(19) United States
(12) Patent Application Publication
(10) Pub. No.: US 2004/0261198 A1
(43) Pub. Date: Dec. 30, 2004

(54) Restructuring and finishing of keratin fibers

(76) Inventors: Sabine Kainz, Moers (DE); Julika Gabler, Duesseldorf (DE); Regina Stehr, Neuss (DE); Frank Naumann, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 10/872,724

(22) Filed: Jun. 21, 2004

Related U.S. Application Data
(63) Continuation of application No. PCT/EP02/14305, filed on Dec. 16, 2002.

(30) Foreign Application Priority Data
Dec. 21, 2001 (DE) 101 63 052.2

(51) Int. Cl. C09B 67/00

(52) U.S. Cl. 8/405

(57) ABSTRACT

A method for modifying keratin fibers, in particular for restructuring and finishing, by polymerizing suitable polymerizable substrates at the fiber by using a polyphenol oxidase. In addition, the invention relates to compositions comprising the substrates capable of the polymerization by means of a polyphenol oxidase and at least one polyphenol oxidase, and to the use thereof for positively influencing the fiber properties, in particular strength, porosity, elasticity, color retention and volume of the fibers.

### CROSS REFERENCE TO RELATED APPLICATIONS

This application is a continuation under 35 U.S.C. § 365(c) and 35 U.S.C. § 120 of international application PCT/EP02/14305, filed on Dec. 16, 2002. This application also claims priority under 35 U.S.C. § 119 of DE 101 63 052.2, filed Dec. 21, 2001, which is incorporated herein by reference in its entirety.

### BACKGROUND OF THE INVENTION

The present invention relates to a method for modifying keratin fibers, in particular for restructuring and finishing, by polymerizing suitable polymerizable substrates at the fiber by use of a polyphenol oxidase. In addition, the invention relates to a composition comprising the substrates capable of the polymerization by means of a polyphenol oxidase and at least one polyphenol oxidase, and to the use thereof for positively influencing the fiber properties, in particular strength, porosity, elasticity, color retention and volume of the fibers. Furthermore, the invention relates to a fibrous keratin material with improved properties obtainable according to the method.

Keratin fibers, in particular hair, being a solid constituent of the human body and being an essential constituent of human clothing and household textiles, are of important significance in everyday life. The treatment with washing, cleaning, styling and coloring products, for cleaning and structuring purposes, and also their exposure to environmental influences, such as ozone, salt water and chlorinated water, IR, UV and thermal radiation (blow-drying) lead, over the course of time, to cumulative damage of the fibers and thus to a reduction in their quality. For example, both the cleansing of the hair with shampoos and also the decorative fashioning of the hairstyle by coloring or permanent waving are interventions which influence the natural structure and the properties of the hair. Consequently, following such a treatment, the wet and dry combability, hold, fullness, shine and tactility of the hair may be unsatisfactory. In the case of colored hair, the color retention on the hair may also be unsatisfactory, particularly when the hair is washed frequently, resulting in gradual bleeding of the color.

For permanent, intensive colorations with corresponding fastness properties, use is made of so-called oxidation colorants. Such colorants usually comprise oxidation dye precursors, so-called developer components and coupler components. The developer components, under the influence of oxidizing agents or of atmospheric oxygen, form with one another or with coupling with one or more coupler components, the actual dyes. Although the oxidation colorants are characterized by excellent, long-lasting coloring results, for natural-looking colorations, it is usually necessary to use a mixture of a relatively large number of oxidation dye precursors; in many cases, direct dyes are also used for the shading. If the dyes which are formed in the course of the color development and/or used directly have markedly different fastnesses (e.g. UV stability, fastness to perspiration, fastness to washing, etc.), then a visible and therefore undesired color shift may arise over time. This phenomenon arises to an increased degree when the hairstyle has hair or sections of hair with varying degrees of damage. One example of this is long hair in which the ends of the hair which have been exposed for a long time to all possible environmental influences are generally more considerably damaged than the relatively newly grown sections of hair.

For temporary colorations, use is usually made of colorants or tints which comprise so-called direct dyes as the coloring component. These are dye molecules which attach directly to the hair and require no oxidative process to develop the color. These dyes include, for example, Henna, which has been known for a long time for coloring body and hair. These colorations are generally significantly more sensitive to shampooing than the oxidative colorations, meaning that an often undesired shift in shade or even a visible “decoloration” arises very much more quickly.

There has been no lack of attempts to improve the fastness of colorations of keratin fibers. One development direction is the optimization of the dyes themselves and/or the synthesis of novel, modified dye molecules. A further development direction is the search for additives for colorants in order to increase the fastness of the colorations. A known solution to the problem is to add UV filters to the colorant. These filter substances are applied to the hair together with the dye during the coloring process, achieving in many cases a significant increase in the stability of the coloration to the effect of daylight or artificial light.

EP 0 655 905 B1 discloses the use of alkyl glycosides in colorants. DE-A 199 190 89 describes hair coloring preparations containing sugar surfactants and fatty acid partial glycerides which strengthen the hair structure and are highly compatible in dermatological terms. However, no information regarding fastness to washing is disclosed.

U.S. Pat. No. 3,619,114 teaches the permanent modification of keratin substrates by copolymerization with vinyl monomers in the presence of free-radical catalysts and subsequent treatment with aqueous ammoniacal copper hydroxide solutions. Due to the toxicity of the compounds used, the application is limited to inanimate keratin fibers. U.S. Pat. No. 2,615,782 teaches the modification of keratin fibers by joining disulfide bridges between hair and active substance. A further method of fixing compounds which serves for the permanent shaping of hair and which is aimed in particular at permanent waving processes, is the use of so-called Bunte salt derivatives, as described in DE-A-3735086, DE-A-4109869 and EP-A-0246151. US-A-3,415,606 teaches the use of reactive dyes which develop a long-term effect on the hair.

EP-A-0953634 discloses a method of treating porous materials by macromolecularization of phenolic compounds or aromatic amines using enzymes with polyphenol-oxidizing activity.

WO-A-0042085 relates to hydrophilic copolymers and/or graft polymers of phenols and further unsaturated monomers which are obtainable by free-radical polymerization with peroxides and hydroperoxides in the presence of oxidizing enzymes. The polymers are used as binders, flocculating agents and thickeners, as drilling, suspending and dispersion auxiliaries, and as auxiliaries in the finishing of textiles and fibers. The free-radical reaction mechanism requires an inert reaction medium.

U.S. Pat. No. 5,770,418 relates to a laccase with good suitability for the coloring of hair by targeted oxidation of a colorant precursor on the hair. Suitable precursors are preferably aromatic compounds chosen from diamines, aminophenols (or aminonaphthols) and phenols.

Lund et al. (in Modification of kraft pulp and lignin by copolymerisation of phenolic compounds initiated by laccase, Int. Conf. Biotechnol. Pulp Pap. Ind., C139-142) describe the modification of cellulose, lignin and sulfate pulp by phenolic monomers using a laccase as polyphenol oxidase.

### SUMMARY OF THE INVENTION

The object of the invention is therefore to provide formulations for the restructuring, finishing and for the protection of keratin fibers by increasing the fiber cross section (voluminous structure), the increase in the strength, the improvement in the elasticity, and the reduction in the porosity. A further object of the invention was to provide formulations which improve the fastness of colorations of keratin fibers. Moreover, the compositions should be free from peroxides and hydroperoxides and thereby permit an application which is gentle to fibers.

### DETAILED DESCRIPTION OF THE INVENTION

For the purposes of the present invention, the object was achieved by a method for modifying fibers which is characterized in that phenolic, arylaminic, enolic and/or enaminic substrates capable of the polymerization are polymerized by means of polyphenol oxidases at a keratin fiber.

The method according to the invention serves to strengthen, protect, and repair keratin fibers. In particular, fiber properties such as strength, porosity, elasticity or volume are influenced in a positive manner. As described above, a positive influence is understood as meaning an increase in the strength, the elasticity and the volume and a reduction in the porosity. The process is also suitable for styling purposes, such as shaping and shape retention, and also for increasing the color fastness, in particular the fastness to washing of colored keratin fibers, in particular colored human hair.

It has been found that through the use of the method according to the invention it is possible to significantly increase the fastness to washing of colorations of, in particular, keratin fibers. For the purposes of the invention, fastness to washing is understood as meaning the retention of the color of a colored keratin fiber with regard to color shade and/or color intensity when the colored fiber is subjected to the influence of aqueous compositions, in particular surfactant-containing compositions such as shampoos.

Keratin fibers are to be understood according to the invention as meaning furs, wool, feathers, silk and hair, in particular human hair.

Since it is only possible to speculate with regard to the precise activity site of the polymers according to the invention, “at the fiber” means in connection with the present invention also that the polymerization can take place in cavities within the fiber, and also at or on the fiber surface.

The swelling of the hair in the wet state is a measure of hair damage. Treatment with the method according to the invention can significantly reduce the swelling of the hair in the wet state. This restructuring effect can be observed particularly with severely damaged hair, such as, for example, with permanently waved hair.

Moreover, a considerable increase in the modulus of elasticity and the stress at break and thus the strength of the fibers treated according to the invention was observed. The method according to the invention is suitable for the restructuring of fibers, in particular for the strengthening and holding of keratin fibers, and very particularly for improving the hair structure and/or for strengthening human hair.

The method according to the invention is also suitable for protecting fibers against the harmful effect of light.

For the purposes of the present invention, the following groups of substrates are suitable for the enzymatic polymerization reactions according to the invention:

I. Phenolic compounds which may be substituted by 1 or 5, preferably 1 to 4, particularly preferably 2 to 3, different or identical groups. The substituents of the phenolic compounds are preferably chosen from the group consisting of:

a) the hydroxyl group. Examples of suitable compounds are phenol, hydroquinone, pyrocatechin, resorcinol, phloroglucinol;

b) aldehyde, keto, sulfonic acid and carboxyl groups. Examples of suitable compounds are mono-, di- or trihydroxybenzaldehydes, amino-hydroxybenzaldehydes, vanillin, syringa aldehyde, mono-, di- or trihydroxybenzoic acid, preferably 2,3-, 3,4-, 3,5-, 2,5-dihydroxybenzoic acid, salicylic acid, syringa acid, vanillin acid, gallic acid and catechol;

c) alkoxy groups having 1 to 12, preferably 1 to 6, particularly preferably 1 to 3, carbon atoms, which may be arranged in a branched or unbranched manner, in particular methoxy groups. An example of such compounds is 2,6-dimethoxyphenol;

d) amino groups which may be substituted by one or two hydrocarbon radicals (to form a secondary or tertiary amino group) comprising 1 to 12, preferably 1 to 6, particularly preferably 1 to 3, carbon atoms or ammonium salts thereof;

e) halogen groups, such as fluorine, chlorine, bromine and iodine, but preferably chlorine;

f) alkyl and alkylene groups which may have 1 to 12, preferably 1 to 6, particularly preferably 1 to 3, carbon atoms, which may be arranged in a branched or unbranched manner, and also the substituents specified under a)-e). Examples of suitable compounds are 4-allyl-2-methoxyphenol, eugenol, 3,4-dihydroxycinnamic acid, biphenyls or polyphenolic compounds whose aromatic rings may be joined via aliphatic hydrocarbon groups having up to 10 carbon atoms, azo compounds or aldazines;

g) mono- or polysaccharide groups which may be joined to phenolic compounds via ether or ester bonds with carbohydrates. Examples of suitable compounds are: tannins, turgorinic acid.

Further examples of substrates according to the invention are: 3-methylcatechol, 4-methylcatechol, 4-nitrocatechol, catechin, 1-catechin, d-catechin, caffeic acid, hydrocaffeic acid, gallic acid, L-tyrosine, shikimic acid, quercetin, 2,4-dichloro-3-aminophenol, rutin, N-acetyl-6-hydroxytryptophan, tryptophan, L-epicatechol, DL-epicatechol, epicatechol gallate, p-coumaric acid, heliogenol, lignin, lignosulfonic acid, humic acid, nitrohumic acid, tannin, urushiol, 4-hydroxy-cinnamyl alcohol, o-coumaric acid, p-coumaric acid, coniferyl alcohol, coniferyl aldehyde, ferulic acid, ethyl-3,4-dihydroxycinnamic acid, 3-hydroxy-4-methoxycinnamic acid, 3,4-dihydroxycinnamic acid, 3-hydroxy-4-methoxycinnamaldehyde, vanillin, o-vanillin, vanillic acid, vanillyl alcohol, o-vanillyl alcohol, isovanillyl alcohol, vanillylamine, vinillylazines, 4-hydroxy-3-methoxybenzonitrile, syringa acid, sinapyl alcohol, sinapic acid, sinapinaldehyde, homovanillic acid, homovanillyl alcohol, homovanillonitrile, hesperidin, chlorogenic acid, hinokitiol, pyrocatechol, hydro-quinone, tert-butylhydroquinone, phenylhydroquinone, trimethylhydroquinone, pyrogallol, lauryl gallate, octyl gallate, 3,4-dihydroxybenzoic acid, 3,5-dihydroxybenzoic acid, 1,2-dihydroxynaphthalene, 2,3-dihydroxynaphthalene, o-hydroxybenzoic acid, p-hydroxybenzoic acid, 4-methoxyphenol, 2,5-dihydroxy-1,4-benzoquinone, 2,5-dihydroxybenzoic acid, methylhydroquinone, ethylhydroquinone, 1-hydroxybenzotriazoles, 2,3-dihydroxypyridazine, 3,6-dihydroxypyridazine, 2,3-, 3,4-, 3,5-, 2,4-dihydroxypyridine, 3,4-dimethoxystyrene, (3,4-dimethoxyphenyl)acetic acid, (3,4-dimethoxy-phenyl)acetonitrile, (3,4-dimethoxyphenyl)acetone, 3-(3,4-dimethoxyphenyl)propionic acid, 4-(3,4-di-methoxyphenyl)butyric acid, 3-(3,4-dimethoxyphenyl)-propanol, 2-methoxy-4-propenylphenol, 3-(3,4-dihydroxyphenyl)-L-alanine, veratraldehyde, veratric acid, veratrol, homoveratric acid, 2′,5′-dimethoxyacetophenone, 3′,4′-dimethoxyaceto-phenones, 3,4-dimethoxycinnamic acid, 3,4-di-methoxycinnamonitrile, 2,3-dimethoxyphenol, 3,4-dimethoxyphenol, 3,4-dimethoxybenzyl alcohol, 2,3-dimethoxybenzoic acid, 2,5-dimethoxybenzoic acid, 1,4-dimethoxybenzene, 3-methoxysalicylic acid, acetylsalicylic acid, methyl salicylate, ethyl salicylate, methyl gallate, bisphenol, bilirubin, propyl gallate, 3,4,5-trimethoxyphenol, tropolone, purpurogallin, salicylaldoximes, 3-amino-5,6,7,8-tetrahydro-2-naphthol, 1,5-dihydroxynaphthalene, 3,5-dihydroxy-2-naphthenic acid, 4-hydroxy-1-naphthalenesulfonic acid, purpurin, 2,3-dihydro-9,10-dihydroxy-1,4-anthracenedione, epinephrine, pyrogallic acid, methyl-4-hydroxy-3-methoxybenzoic acid, 6,7-dihydroxy-2-naphthalene-sulfonic acid, anthrarobin, alizarin, quinizarin, phloroglucinol, hydroquinone monomethyl ether, N-methylcoclaurine, tannic acid, N-acetyldopamine (N-acetyldopamine quinone), dopamine, N-formyl-L-tyrosine, tyramine (o-dihydroxybenzene), pyrogallol, α-methyldopaquinone, adrenaline bitartrate, trans-p-hydroxycinnamic acid, phloridzin, 3-hydroxyphloridzin, L-adrenaline, protocatechuic acid, 4-dihydroxybenzoic acid, esculetin, noradrenaline, epigallocatechin gallate, p-cresol, ferulic acid, sinapic acid, d-catechin, clorogenic acid, 2-naphthol, p-methoxyphenol, 2,6-dimethoxyphenol, o,m,p-chlorophenol, 2,4-dichlorophenol, 2,6-dichlorophenol, 2,6-dimethyl-phenol, phenol, 4-chloro-2-methylphenol, p-aminophenol, ferrocyanide, dopa, pyrocatechin, o,m,p-cresol, resorcinol and resorcinol derivatives, pyrazolones, 3,5-dimethoxyhydroxybenzaldazine, benzosemiquinone, 1,2,4-benzenetriol, (S)-coclaurine, phloroglucinol, 1,5-, 2,7- and 1,7-dihydroxynaph-thalene, resorcinol monomethyl ether, hydroquinone monomethyl ether, N-methylcoclaurine, (R)-coclaurine, 4-chlororesorcinol, 2-chloro-6-methyl-3-aminophenol, (S)-coclaurine, 1,3-bis(2,4-diaminophenoxy)propane, 2-methylresorcinol, 5-methylresorcinol, 2,5-dimethylresorcinol, 2,6-dihydroxypyridine, o-phenylenediamine, 1-naphthyl, 1,5-, 2,7- and 1,7-dihydroxynaphthalene, m-aminophenol, resorcinol monomethyl ether, 2-methylresorcinol, 5-methylresorcinol, 2-chlororesorcinol, 4-chloro-resorcinol, 1-phenyl-3-methylpyrazol-5-one, 5-amino-2-methylphenol, 3,4-diaminobenzophenone, o-anisidine, p-anisidine, o-aminophenol, p-aminophenol, 1,3-bis(2,4-diaminophenoxy)propane, 2-chloro-6-methyl-3-aminophenol, 2-methyl-4-chloro-5-aminophenol, (S)-coclaurine, 1,3-bis(2,4-diamino-phenoxy)propane, 2-methylresorcinol, 5-methylresorcinol, 2,5-dimethylresorcinol, 2,6-dihydroxypyridine, o-phenylenediamine, 1,5-, 2,7- and 1,7-dihydroxynaphthalene, m-aminophenol, resorcinol, resorcinol monomethyl ether, 2-methyl-resorcinol, 5-methylresorcinol, 2-chlororesorcinol, 4-chlororesorcinol, 1-phenyl-3-methylpyrazol-5-one, 5-amino-2-methylphenol, 3,4-diaminobenzophenone, o-anisidine, p-anisidine, o-aminophenol, p-aminophenol, 1,3-bis(2,4-diaminophenoxy)propane, 2-methyl-4-chloro-5-aminophenol, 1,2-diamino-anthraquinone, 1,4-diaminoanthraquinone, 2,3,4-trihydroxybenzaldehyde, 3-(2,4)-, 3-(2,3)-, 3-(3,5)-, 3-(2,6)- and (3,4-dihydroxyphenyl)alanine and derivatives of these compounds.

Besides the known dihydroxybenzenes (pyrocatechin, resorcinol, hydroquinone), phloroglucinol and pyrogallol, the polyphenols may also be polynuclear aggregates and products of oligomerization, such as, for example, the compounds of the formulae I to IV or derivatives thereof.

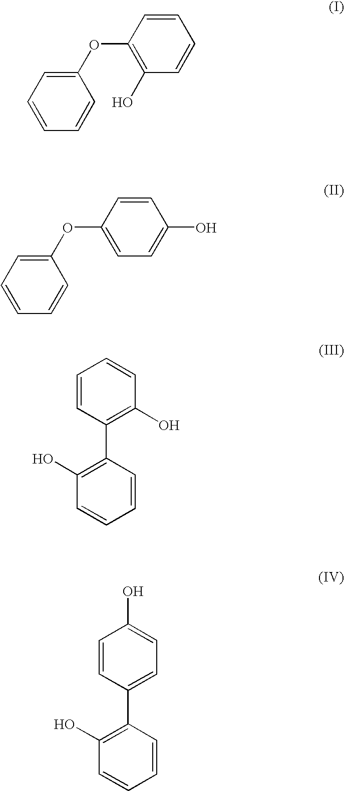

Particular preference is given to the anthocyanides, proanthocyanides, flavones, catechins and tannins.

II. Aromatic amines which have at least one further functional group which is chosen from a)-g). Examples of aromatic amines which can be used according to the invention are customary primary aromatic amines with a further free or substituted hydroxyl or amino group, diaminopyridine derivatives, heterocyclic hydrazones, 4-aminopyrazolone derivatives such as 2,4,5,6-tetramino-pyrimidine and derivatives thereof, p-phenylenediamine, p-toluylenediamine, 2,4,5,6-tetraminopyrimidine, p-aminophenol, N,N-bis(2-hydroxyethyl)-p-phenylenediamine, m-phenylenediamine, 2-(2,5-diaminophenyl)ethanol, 2-(2,5-diaminophenoxy)ethanol, 1-phenyl-3-carboxyamido-4-aminopyrazol-5-one, p-phenylenediamine, 4-amino-3-methylphenol, 2-aminomethyl-4-aminophenol, 2-hydroxy-4,5,6-triaminopyrimidine, 2,4-dihydroxy-5,6-diaminopyrimi-dine, 2,5,6-triamino-4-hydroxypyrimidine, 4,4′-ethylenedianiline, 4,5-diamino-6-hydroxy-2-mercaptopyrimidine, 2,3-diaminopyridine, 6-hydroxy-2,4,5-triaminopyrimidine, 4,5,6-triaminopyrimidine, ABTS (2,2′-azobis(3-ethylbenzothiazoline-6-sulfonic acid), 2-amino-3-hydroxypyridine, 3-amino-2-methoxybenzofuran, 2,4-dimethoxyanilines, 2,5-dimethoxyaniline, 3,4-dimethoxyaniline, veratrylamine, homoveratrylamine, homoveratronitrile, 3,4-dimethoxyphenethylamine, 2-methoxy-5-methylaniline, 2-methoxy-5-nitroaniline, 4-methoxy-2-nitroaniline, 3,4,5-trimethoxyaniline, p-phenylenediamine, 4,5-dimethyl-o-phenylenediamine, 4-amino-N,N′-dimethylaniline and m-aminophenols, p-phenylenediamine, p-toluylenediamine, p-aminophenol, 1-(2′-hydroxyethyl)-2,5-diaminobenzene, N,N-bis(2-hydroxyethyl)-p-phenylenediamine, 2-(2,5-diaminophenoxy)ethanol, 1-phenyl-3-carboxyamido-4-aminopyrazol-5-one, 4-amino-3-methylphenol, 2-methylamino-4-aminophenol, 2,4,5,6-tetraminopyrimidine, 2-hydroxy-4,5,6-triaminopyrimidine, 4-hydroxy-2,5,6-triaminopyrimidine, 2,4-dihydroxy-5,6-diaminopyrimidine, 2-dimethylamino-4,5,6-tri-aminopyrimidine, 2-hydroxyethylaminomethyl-4-aminophenol, 4,4′-diaminodiphenylamine, o-aminophenol, 5-amino-2-methylphenol, m-aminophenol, m-phenylenediamine, 1-phenyl-3-methylpyrazol-5-one, 2,4-dichloro-3-aminophenol, 2,6-diaminopyridine, 2-amino-3-hydroxypyridine, 2,6-dihydroxy-3,4-diaminopyridine, 3-amino-2-methylamino-6-methoxypyridine, 4-amino-2-hydroxytoluene, 2,6-bis(2-hydroxyethylamino)toluene, 2,4-diaminophenoxyethanol, 2-amino-4-hydroxyethylaminoanisole and 1,3-N,N′-bis(2′-hydroxylethyl)-N,N′-bis(4′-amino-phenyl)diaminopropan-2-ol.

III. Enolic compounds having 2 to 20, preferably 4 to 18, particularly preferably 6 to 12, carbon atoms, which have at least one further functional group which is chosen from a)-g). Examples of such compounds are ascorbic acid, isoascorbic acid, 3,4-dihydroxy-3-cyclobutene-1,2-dione, morpholinocyclopent-1-ene, morpholinocyclohex-1-ene and 1-hydroxycyclohexene.

IV. Enaminic compounds having 2 to 20, preferably 4 to 18, particularly preferably 6 to 12, carbon atoms, which have at least one further functional group which is chosen from a)-g). Examples of such compounds are pyrrolidinocyclopent-1-ene, pyrroli-dinocyclohex-1-ene, piperidinocyclohex-1-ene, ethyl β-aminocrotonate, ethyl β-methylaminocrotonate, ethyl β-dimethylaminocrotonate, ethyl β-anilinocrotonate, β-benzylaminocrotonic ester, ethyl 0-benzylaminocrotonate, 4-aminopent-3-en-2-one, 4-benzylaminopent-3-en-2-one, 1-cyclopentene-1-amine, 1,4-cyclopentadiene-1-amine.

### V. Combinations of the Compounds According to I to IV

Phenolic compounds for the purposes of the present invention are mono-, bi-, tri- or polynuclear aromatics with at least 5, preferably 6 to at most 32, preferably at most 24, particularly preferably at most 12, carbon atoms and, if desired, up to 3, preferably 1 or 2, heteroatoms, chosen from oxygen, nitrogen and sulfur, which have at least one hydroxyl group on the aromatic ring.

Aromatic compounds for the purposes of the present invention are mono-, bi-, tri- or polynuclear aromatics with at least 5, preferably 6 and at most 32, preferably at most 24, particularly preferably at most 12, carbon atoms and if desired up to 3, preferably 1 to 2 heteroatoms, chosen from oxygen, nitrogen and sulfur.

For the purposes of the present invention, enolic/enaminic compounds are α,β-unsaturated alcohols (enols) or α,β-unsaturated amines (enamines), and derivatives thereof which can additionally have further conjugated double bonds.

The substrates which can be used according to the invention can of course be used not only in pure form or in the form of mixtures of different pure substrates, but the substrates can also be used in the form of substances which contain at least one of the above-mentioned substrates. Examples of such substances are vegetable extracts, such as, for example, the phenol-containing extracts of green tea, grapes or grape seeds.

The abovementioned substrates are, in particular monomeric substrates. Moreover, however, it is also possible to use oligomers which are constructed from the abovementioned monomeric substrates as substrates.

For the purposes of the present invention, combinations of two or more different monomeric substrates can also be polymerized with one another.

Furthermore, a copolymerization with suitable alkene and vinyl derivatives which are accessible to a free-radical, ionic or coordinative chain polymerization is also possible. Such copolymerizations permit, for example, the combination with UV filters or active ingredients for antimicrobial finishing.

In addition, further quinoid compounds can be brought to polymerization as substrates or as comonomers in combination with the substrates mentioned above under I to V.

Examples of such quinoid compounds are anthaquinone-2-sulfonic acid, anthraquinone-1,5-disulfonic acid, anthraquinone-2,6-disulfonic acid, anthraquinone-2-carboxylic acid, 1-aminoanthraquinone, 2-aminoanthraquin-one, anthrarufin, aminonaphthoquinone, 1,8-dihydroxy-anthraquinone, camphorquinone, dehydroascorbic acid, 2-hydroxy-1,4-naphthoquinone, isatin and 5-nitroisatin.

In addition, the polymerization can take place in the presence of compounds which are accessible to an autoxidation. Examples of such compounds are unsaturated fatty acids, such as oleic acid, rinoleic acid, unsaturated alcohols, such as oleyl alcohol, alkenes, such as squalene, and varnish oils, such as tung oil, linseed oil, castor oil, etc.

The targeted selection and arrangement of the substrates allows the desired properties of the resulting polymers and copolymers to be matched. Such properties which develop on the fiber are, for example, resistance to the effect of UV, IR and heat, improved combability, resistance to mechanical deformation (creasing), improvement in the feel, shine, stress, elasticity and color resistance, the targeted antimicrobial finishing and impregnation of the fibers against moisture, soiling, and also allergenic adherence (such as, for example, flower pollen).

If the effect intended using the process according to the invention is an improvement in the color resistance, i.e. expressed another way, is an increase in the color fastness of colored hair, when choosing the substrates, an intrinsic coloration of the resulting polymers which may arise must be taken into consideration. While this intrinsic coloration is generally insignificant when using the process according to the invention on fibers which are per se already dark in color and/or brown in color, the intrinsic coloration of the polymer when used on pale fibers, such as, for example blonde hair, may be undesired. However, it is directly possible for the person skilled in the art, by means of simple preliminary experiments, to ascertain whether such an undesired effect is to be expected for a particular embodiment of the invention under consideration.

Preferably, for the process according to the invention, substrate and polyphenol oxidase are chosen such that the polymer formed therefrom during the polymerization at a keratin fiber has no perceptible intrinsic coloration. The perceptibility of an intrinsic coloration of the polymer naturally depends on the original color shade of the fibers. If, for example, the process according to the invention is to be used for holding or increasing the volume of black hair, then even a significant intrinsic color of the polymer may be tolerable. If, on the other hand, the same effects are to be achieved on blonde hair, then substrate and polyphenol oxidase are to be chosen such that the polymer has at worst a weak intrinsic coloration. In any case, a coloration which may arise and which is effected as a result of the process according to the invention on the treated fibers does not represent an effect which is desired according to the invention, but an accompanying phenomenon.

According to conventional methods of the prior art, the polymerization of phenols or other substrates capable of polymerization takes place under drastic reaction conditions, such as, for example, using peroxides or hydroperoxides which rule out a fiber-gentle polymerization at the fiber. In contrast to this, the enzymatic polymerization of the substrates according to the invention opens up, as a result of their gentle effect on fibers, hair and skin, the possibility of direct application to the fibers, in particular to living and keratinized hair. The process according to the invention can be carried out under mild, physiological conditions and, in particular, requires no physiologically unacceptable polymerization initiators, such as, for example, free-radical formers. The fibers treated according to the invention have higher tear strength and an increased individual fiber diameter compared with untreated fibers.

The enzymes used according to the invention are those which are capable of the polymerization of the substrates specified under I to V. Of particular suitability for this purpose are polyphenol oxidases which are chosen from the group consisting of laccases E.C.[1.10.3.2], catechol oxidases E.C.[1.10.3.1], ascorbate oxidases E.C.[1.10.3.3], tyrosinases E.C.[1.14.8.1], bilirubin oxidases E.C.[1.3.3.5] or combinations thereof. The polyphenol oxidases are obtainable as a matter of priority from microorganisms such as Phanerochaete, Bjerkandera, Aspergillus, Streptomyces, Myceliophthora, Melanocarpus, Polyporus, Myrothecium, Ascomycota and Basidiomycota, and also from plants such as apple, lemon or tomato.

As enzymes, particular preference is given to polyphenol oxidases from the fungi Trametes, Myceliophthora, Melanocarpus and Thielavia.

The enzymes can be used in conjunction with suitable mediators. Examples of such mediators are hydroxybenzotriazoles (HBT), violuric acid (Vio), N-hydroxyacetanilide, N-hydroxy-N-phenylacetamide (NHA), methyl syringate, 10-phenothiazinepropionic acid, 2,2′-azinobis (3-ethylbenzothiazoline-6-sulfonic acid (ABTS), 2,2,6,6-tetramethyl-1-piperidinyloxy (TEMPO), 2-nitroso-1-naphthol-4-sulfonic acid (HNNS), Remazol Brilliant Blue, 3-hydroxyanthranilic acid and 2-pyridinecarboxylic acid.

Furthermore, the present invention relates to a keratin, fibrous material obtainable by the process described above which has increased tear strength of the fibers coupled with increased volume and/or an increased color fastness in cases where the keratin fibrous material is colored.

If the process according to the invention serves to improve the color fastness and/or the washing resistance of colored keratin fibers, then it is preferably carried out separately from the coloring process, namely after the coloring process.

It is, however, also possible to carry out the process according to the invention for improving the color fastness and/or the washing resistance of colored keratin fibers at the same time as the coloring process.

In a further embodiment, the invention relates to a composition comprising the abovementioned enzyme/substrate combinations for the treatment of keratin fibers, in particular of hair.

To improve the shelf life of the compositions according to the invention, the enzymes and the substrates are preferably prepared separately from one another in the form of a multicomponent system and mixed together shortly before or during application to the fibers. Thus, the substrates according to the invention can be applied to the hair, for example, in a shampoo formulation, and then admixed with the enzyme which is prepared, for example, in the form of a rinse. As a result of the treatment with the composition according to the invention, by increasing the fiber volume of the individual fibers and the tear strength, it is possible to bring about restructuring of the fibers. In addition, higher color resistance (color fastness) can be imparted to colored hair, i.e. the color of colored hair can be made more resistant to washing out.

In the compositions according to the invention, the polyphenol oxidase is used in an amount of from 0.1 to 50 U/ml, preference being given to amounts of from 0.01 to 50 U/ml, particularly preferably from 0.05 to 1 U/ml. The amounts given refer in each case to the 0.01 to 10% by weight, preferably 0.1 to 5% strength by weight, in particular aqueous, substrate solution. The activity of the polyphenol oxidase is defined here such that one unit [1 U] of polyphenol oxidase corresponds to 1 μmol/min of unreacted syringaldazine at 30° C. and pH=6.5.

In addition to the substrates and the enzyme, the compositions may have a carrier. The substrates and the enzyme are present therein in a total amount of from 0.01 to 10% by weight, preferably 0.1 to 5% by weight, based on the total composition comprising the substrates, the enzyme and the carrier. The ratio of enzyme to substrate is preferably 1-10 U of polyphenol oxidase per 5-100 mg of substrate.

Suitable carriers are solid, liquid, gel-like or pasty and are preferably chosen from aqueous systems, natural or synthetic oils, water-in-oil or oil-in-water emulsions. Such systems and processes for their preparation are known in the prior art, to which reference is hereby made.

The composition can additionally comprise customary active ingredients, auxiliaries and additives. Such active ingredients, auxiliaries and additives are, for example:

anionic surfactants, such as alkyl sulfates, alkyl polyglycol ether sulfates and ether carboxylic acids having 10 to 18 carbon atoms in the alkyl group and up to 12 glycol ether groups in the molecule, and in particular salts of saturated and in particular unsaturated C₈-C₂₂-carboxylic acids, such as oleic acid, stearic acid, isostearic acid and palmitic acid,

ampholytic surfactants, such as, for example, N-alkyglycines, N-alkylpropionic acids, N-alkyl-iminobutyric acids, N-alkyliminodipropionic acids, N-hydroxyethyl-N-alkylamidopropylglycines, N-alkyl-taurines, N-alkylsarcosines, 2-alkylaminopropionic acids and alkylaminoacetic acids having in each case about 8 to 18 carbon atoms in the alkyl group. Particularly preferred ampholytic surfactants are N-cocoalkylaminopropionate, cocoacylaminoethyl-aminopropionate and C₁₂₋₁₈-acylsarcosine,

nonionic surfactants, such as, for example, the addition products of from 2 to 30 mol of ethylene oxide and/or 0 to 5 mol of propylene oxide onto linear fatty alcohols having 8 to 22 carbon atoms, onto fatty acids having 12 to 22 carbon atoms and onto alkyl phenols having 8 to 15 carbon atoms in the alkyl group; C₁₂₋₂₂-fatty acid mono- and diesters of addition products of from 1 to 30 mol of ethylene oxide onto glycerol; C₈₋₂₂-alkyl mono- and oligoglycosides and ethoxylated analogs thereof; addition products of from 5 to 60 mol of ethylene oxide onto castor oil and hydrogenated castor oil; addition products of ethylene oxide onto sorbitan fatty acid esters; addition products of ethylene oxide onto fatty acid alkanolamides; amine oxides,

cationic surfactants, such as, for example, quaternary ammonium compounds. Preference is given to ammonium halides, such as alkyltrimethylammonium chlorides, dialkyldimethylammonium chlorides and dialkylmethylammonium chlorides, e.g. cetyltrimethylammonium chloride, stearyltrimethyl-ammonium chloride, distearyldimethylammonium chloride, lauryldimethylammonium chloride, lauryl-dimethylbenzylammonium chloride and tricetyl-methylammonium chloride. Further cationic surfactants which can be used according to the invention are the quaternized protein hydrolyzates,

zwitterionic surfactants are the so-called betaines, such as the N-alkyl-N,N-dimethylammonium glycinates, for example cocoalkyldimethylammonium glycinate, N-acylaminopropyl-N,N-dimethylammonium glycinate, for example cocoacylaminopropyldimethylammonium glycinate, and 2-alkyl-3-carboxymethyl-3-hydroxyethylimidazolines having in each case 8 to 18 carbon atoms in the alkyl or acyl group, and cocoacylaminoethyl hydroxyethylcarboxymethyl glycinate. A preferred zwitterionic surfactant is the fatty acid amide derivative known under the INCI name Cocamidopropyl Betaine.

nonionic polymers, such as, for example, vinylpyrrolidone/vinylacrylate copolymers, poly-vinylpyrrolidone and vinylpyrrolidone/vinyl acetate copolymers and polysiloxanes,

cationic polymers, such as quaternized cellulose ethers, polysiloxanes with quaternary groups, dimethyldiallylammonium chloride polymers, acrylamide-dimethyldiallylammonium chloride copolymers, dimethylaminoethyl methacrylate-vinyl-pyrrolidone copolymers quaternized with diethyl sulfate, vinylpyrrolidone-imidazoinium methochloride copolymers and quaternized polyvinyl alcohol,

zwitterionic and amphoteric polymers, such as, for example, acrylamidopropyltrimethylammonium chloride/acrylate copolymers and octylacrylamide/methyl methacrylate/tert-butylaminoethyl meth-acrylate/2-hydroxypropylmethacrylate copolymers,

anionic polymers, such as, for example, polyacrylic acids, crosslinked polyacrylic acids, vinyl acetate/crotonic acid copolymers, vinyl-pyrrolidone/vinylacrylate copolymers, vinyl acetate/butyl maleate/isobornyl acrylate copolymers, methyl vinyl ether/maleic anhydride copolymers and acrylic acid/ethyl acrylate/N-tert-butylacrylamide terpolymers,

thickeners, such as agar agar, guar gum, alginate, xanthan gum, gum arabic, karaya gum, carob seed flour, linseed gums, dextrans, cellulose derivatives, e.g. methylcellulose, hydroxyalkylcellulose and carboxymethylcellulose, starch fractions and derivatives, such as amylose, amylopectin and dextrins, clays, such as, for example bentonite or completely synthetic hydrocolloids, such as, for example, polyvinyl alcohol,

structurants, such as glucose and maleic acid,

hair-conditioning compounds, such as phospholipids, for example soya lecithin, egg lecithin and cephalins, and also silicone oils,

protein hydrolyzates, in particular elastin, collagen, keratin, milk protein, soya protein and wheat protein hydrolyzates, condensation products thereof with fatty acids, and quaternized protein hydrolyzates,

perfume oils, dimethyl isosorbide and cyclodextrins,

solubility promoters, such as ethanol, isopropanol, ethylene glycol, propylene glycol, glycerol and diethylene glycol,

antidandruff active ingredients, such as piroctone olamine and zinc omadine,

conventional substances for adjusting the pH,

active ingredients, such as panthenol, pantothenic acid, allantoin, pyrrolidonecarboxylic acids and salts thereof, plant extracts and vitamins, amino acids,

cholesterol,

photoprotective agents,

consistency-imparting agents, such as sugar esters, polyol esters or polyol alkyl ethers,

fats and waxes, such as spermaceti, beeswax, montan wax, paraffins, fatty alcohols and fatty acid esters,

fatty acid alkanolamides,

complexing agents, such as EDTA, NTA and phosphonic acids,

swelling and penetration substances, such as glycerol, propylene glycol monoethyl ether, carbonates, hydrogencarbonates, guanidines, ureas, and primary, secondary and tertiary phosphates,

opacifiers, such as latex,

pearlizing agents, such as ethylene glycol mono- and distearate,

propellants, such as propane-butane mixtures, N₂O, dimethyl ether, CO₂ and air, and

antioxidants.

The compositions according to the invention can be used in hair care compositions, such as shampoos, conditioners, rinses, aerosols and gels, or else in compositions for the treatment of textiles or fibers, in the form of detergents, fabric softeners, impregnating compositions and finishes.

Application of substrate and enzyme to the fiber to be treated can take place successively or after prior mixing of enzyme and substrate. However, the latter application form presupposes that the polymerization does not take place immediately after the mixing of substrate and enzyme.

In one embodiment, the substrates, the enzyme and optionally further constituents of the composition being used are provided separately from one another in a kit-of-parts. The individual components can be present in mixed, dissolved, dispersed or emulsified form in a suitable carrier. Combining the constituents of the kit-of-parts gives the above-described composition according to the invention.

The invention is explained in more detail by the examples below, without, however, being limited thereto.

### EXAMPLES

To illustrate the effect according to the invention, the two-component systems according to the invention of polyphenol oxidase and substrate were either aqueous or incorporated into formulations for hair care and applied to previously damaged hair (hair type: natural dark brown, Code#6634 from Alkinco). By way of example, a treatment of 15 minutes for active ingredients plus a further 15 minutes for enzyme suspension was chosen. Further application conditions such as, for example, 10+10 minutes at a temperature of 36° C. are also conceivable.

### 1. Measurement Apparatuses

To detect the effects according to the invention, a Dia-Stron MTT 670 was used to determine tensile values, gradients, modulus of elasticity, elongation at break and stress at break of the wet hair. The hair cross-sectional area of the wet or dry individual hairs was determined using contactless projection measurement by laser technology known in the prior art. For this purpose, use was made of a universal dimension-measuring device model UMD5000 A from Zimmer.

### 2. Statistical Evaluation

The T test, a statistical evaluation, with which the measurement series are compared bilaterally, in pairs, gives percentage probabilities of the measurement series being different (difference: 90-95% of measurement series are tendentially different, >95% of measurement series are different, >99% of measurement series are highly significantly different).

### 3. Restructuring

3.1 Hair treatment

40 individual hairs were divided into two parts and cyclically transposed. The one part was damaged by two cold waves, the other part in each case was treated with an aqueous active ingredient solutions after the cold wave. All 80 individual hairs were subjected to a hair cross-sectional area determination in the wet state before determining the breaking curves.

### 3.2 Application of the solutions:

a) 30 min application of the cold wave ═CW (7% TGA=thioglycolic acid, 0.3% Turpinal SL (1-hydroxyethane-1,1-diphosphonic acid), 3.5% (NH₄)₂CO₃, pH 8.4). The hairs are then rinsed for 5 minutes with water.

b) 10 min application of the neutralizer (2% H₂O₂, 1% Turpinal SL, pH 4.0). The hairs are then rinsed for 5 minutes with water.

c) 17 h conditioning of the hairs at 32° C. and 20% relative humidity.

d) Measurement of the hair cross sections of the individual hairs.

e) 15 minutes treatment with an aqueous substrate solution (75 ml 2% strength dissolved in Tris/HCl buffer) at 32° C.

f) Addition of 10 ml of enzyme solution and treatment for a further 15 min at 32° C.

g) The hairs are rinsed with water for 10 sec.

h) 17 h conditioning of the hairs at 32° C. and 20% relative humidity.

i) Measurement of the hair cross sections of the individual hairs.

j) Determination of the tensile values of the individual hairs.

Enzymes:

DeniLite™ (polyphenol oxidase from the fungus Myceliophtora+mediator methyl syringate)

DeniLiteBase™ (polyphenol oxidase from Myceliophtora without mediator methyl syringate)

Polyphenol oxidase from the fungus Melanocarpus

Polyphenol oxidase from the fungus Thielavia

Polyphenol oxidase from the fungus Trametes

DeniLite®: (enzyme slurry in Tris/HCl buffer, diluted 1:20, activity 5.4 U/ml, pH=7.5)

DeniLiteBase®: DLB, 2% strength by weight solution, 826 LAMU/g (unit of novocymes)

Polyphenol oxidase from the fungus Melanocarpus, dilution 1:5, 265 ncat/ml

Polyphenol oxidase from the fungus Thielavia, dilution 1:5, 254 ncat/ml

Polyphenol oxidase from the fungus Trametes, dilution 1:5, 200 ncat/ml

### 3.3 Results of Gallic Acid/DeniLite Restructuring

Reference example only damaged hair: as described under 3.2, steps a), b), g); repetition of steps a), b), g); i) in the wet state, j) in the wet state.

Reference example damaged hair treated only with gallic acid: as described under 3.2, steps a), b), e) gallic acid, pH 7.5, g); repetition of steps a), b), e) gallic acid, pH 7.5, g); i) in the wet state, j) in the wet state.

Example according to the invention: damaged hair, hair treated with gallic acid and enzyme solution, as described under 3.2: steps a), b), e) gallic acid, pH 7.5, f) DeniLite g); repetition of steps a), b), e) gallic acid, pH 7.5, f) DeniLite g); i) in the wet state, j) in the wet state.

The influence of the composition according to the invention on hair was investigated by means of stress-strain measurement and hair cross section investigations in the wet state. No structure improvement is found as a result of the treatment only with gallic acid. A significant improvement in the hair structure compared with the reference was found as a result of the treatment with gallic acid and DeniLite. A significant reduction in the hair cross-sectional area of hair treated with gallic acid and DeniLite compared with the untreated individual hairs and the individual hairs treated only with gallic acid was observed. Since the swelling of the hair correlates to their damage, the observed decrease in the cross-sectional area suggests lesser swelling of the hair as a result of a repair effect of the composition according to the invention. In addition, a significant increase in the modulus of elasticity in Hook's range as a measure of the resistance of the material to elastic deformation, and also an increase of highest significance in the stress at the breaking point was observed.

| | | | |
|---|---|---|---|
| Hair cross- | Modulus of | Elongation at | Stress at |
| sectional area | elasticity | break | break |
| [μm²] | [N/m²] | [%] | [N/μm²] |

Reference damaged twice by CW

| | | | |
|---|---|---|---|
| 4.56E+03 | 8.39E+08 | 58.2 | 1.21E−04 |

Reference damaged twice with CW and in between times
treated twice with gallic acid

| | | | |
|---|---|---|---|
| 4.76E+03 | 8.37E+08 | 56.6 | 1.16E−04 |

t-Test, in pairs, bilateral

| | | | |
|---|---|---|---|
| significantly | not different | not different | not different |
| different | | | |

Reference damaged twice by CW

| | | | |
|---|---|---|---|
| 4.65E+03 | 8.11E+08 | 58.7E+01 | 1.23E−04 |

Example according to the invention damaged twice with CW and in between times treated twice with gallic acid+DeniLite

| | | | |
|---|---|---|---|
| 4.46E+03 | 8.99E+08 | 61.4E+01 | 1.44E−04 |

t-Test, in pairs, bilateral

| | | | |
|---|---|---|---|
| significantly | highly | tendentially | extremely |
| different | significantly | different | highly |
| | different | | significantly |
| | | | different |

### 3.4 Results of Catechol/DeniLite Restructuring

Reference example: damaged hair treated only with catechol: as described under 3.2, steps a), b), e) catechol, pH 6.5, g); repetition of steps a), b), e) catechol, pH 6.5, g); i) in the wet state, j) in the wet state.

Example according to the invention damaged hair, hair treated with catechol and enzyme solution, as described under 3.2: steps a), b), e) catechol, pH 6.5, f) DeniLite g); repetition of steps a), b), e) catechol, pH 6.5, f) DeniLite g); i) in the wet state, j) in the wet state.

As a result of the treatment with catechol, the parameters of the Hook range, modulus of elasticity and gradient are significantly reduced compared with permanently waved hair. Likewise significantly smaller are the parameters of the plateau range, stress and work. Overall, it is possible to speak of a significant impairment of the hair structure as a result of the treatment with catechol. As a result of the treatment with the two-component system catechol and DeniLite, the hair structure can be significantly improved, which is equivalent to a repair effect. All stress values, and also the type of work are significantly greater than in the case of permanently waved hair.

| | | | | | | |
|---|---|---|---|---|---|---|
| Modulus | | Plateau | | | | |
| of | Elastic | range | Stress at | Stress at | Stress | Total |
| elasticity | gradient | stress | 15% elongation | 25% elongation | at break | work |
| [N/m²] | [N/mm] | [N/μm²] | [N/μm²] | [N/μm²] | [N/μm²] | [J] |

Reference damaged twice by CW

| | | | | | | |
|---|---|---|---|---|---|---|
| 9.03E+08 | 4.14E−02 | 3.11E−05 | 2.91E−05 | 3.74E−05 | 1.34E−04 | 4.74E−03 |

Reference damaged twice by CW and in between
treated twice with catechol

| | | | | | | |
|---|---|---|---|---|---|---|
| 8.43E+08 | 3.93E−02 | 2.82E−05 | 2.67E−05 | 3.34E−05 | 1.28E−04 | 4.37E−03 |

t-Test, in pairs, bilateral

| | | | | | | |
|---|---|---|---|---|---|---|
| Extremely | Extremely | Extremely | Extremely | Extremely | Not | Not |
| highly | highly | highly | highly | highly | different | different |
| significantly | significantly | significantly | significantly | significantly | | |
| different | different | different | different | different | | |

Reference damaged twice by CW

| | | | | | | |
|---|---|---|---|---|---|---|
| 8.35E+08 | 3.85E−02 | 2.82E−05 | 2.67E−05 | 3.33E−05 | 1.22E−04 | 4.15E−03 |

Example according to the invention damaged twice with CW and in between treated with catechol+DeniLite

| | | | | | | |
|---|---|---|---|---|---|---|
| 8.64E+08 | 3.95E−02 | 3.20E−05 | 3.02E−05 | 3.82E−05 | 1.36E−04 | 4.72E−03 |

t-Test, in pairs, bilateral

| | | | | | | |
|---|---|---|---|---|---|---|
| Not | Not | Extremely | Extremely | Extremely | Extremely | Extremely |
| different | different | highly | highly | highly | highly | highly |
| | | significantly | significantly | significantly | significantly | significantly |
| | | different | different | different | different | different |

### 3.5 Results of Catechol/DeniLiteBase Restructuring

Example according to the invention: damaged hair, hair treated with catechol and enzyme solution, as described under 3.2: steps a), b), e) catechol, pH 6.5, f) DeniLiteBase g); repetition of steps a), b), e) catechol, pH 6.5, f) DeniLiteBase g); i) in the wet state, j) in the wet state.

As a result of the treatment with catechol and DeniLiteBase, an increase in the modulus of elasticity, the stress values in the plateau range and the stress at break is found. Due to the significant reduction in plastic elongation and elongation at break, the work in the plateau range and the total work is not or is tendentially different. The reduction in the elongation values is deemed to be positive. The significantly smaller hair cross-sectional area of the treated hair should be emphasized since the treatment suppresses the swelling by the permanent wave (with a measure of the damage). Accordingly, the treatment with catechol and DeniLiteBase leads to an improvement in hair structure.

| | | | | | | |
|---|---|---|---|---|---|---|
| Hair cross- | | Plateau | | Stress at | Elongation | |
| sectional | Modulus of | range | Stress at 15% | 25% | at | Stress |
| area | elasticity | stress | elongation | elongation | break | at break |
| [μm²] | [N/m²] | [N/μm²] | [N/μm²] | [N/μm²] | [%] | [N/μm²] |

Reference damaged twice by CW

| | | | | | | |
|---|---|---|---|---|---|---|
| 4.62E+03 | 8.94E+08 | 2.94E−05 | 2.78E−05 | 3.38E−05 | 5.90E+01 | 1.22E−04 |

Example according to the invention damaged twice with CW and in between treated twice with catechol+DeniLite Base

| | | | | | | |
|---|---|---|---|---|---|---|
| 3.67E+03 | 1.12E+09 | 3.60E−05 | 3.49E−05 | 4.24E−05 | 5.47E+01 | 1.48E−04 |

t-Test, in pairs, bilateral

| | | | | | | |
|---|---|---|---|---|---|---|
| Extremely | Extremely | Extremely | Extremely | Extremely | Extremely | Extremely |
| highly | highly | highly | highly | highly | highly | highly |
| significantly | significantly | significantly | significantly | significantly | significantly | significantly |
| different | different | different | different | different | different | different |

### 3.6 Results of Catechol/DeniLiteBase/1-Hydroxybenzotriazole Restructuring

Example according to the invention damaged hair, hair treated with catechol and enzyme solution, as described under 3.2: steps a), b), e) 75 ml of catechol, pH 6.5, 2% strength, f) 10 ml in DeniLiteBase/25 ml of 1-hydroxybenzotriazole g); repetition of steps a), b), e) catechol, pH 6.5, 2% strength, f) 10 ml of DeniLiteBase/25 ml of 1-hydroxybenzotriazole g); i) in the wet state, j) in the wet state.

The modulus of elasticity and the gradient of Hook's range are significantly increased as a result of the treatment. The plastic elongation and the elongation at break are significantly reduced. As a result, there is a slight improvement in the hair structure.

| | | | | | |
|---|---|---|---|---|---|
| Modulus | | | Work at | | Elongation |
| of | Elastic | Elastic | 15% | Plastic | at |
| elasticity | gradient | elongation | elongation | elongation | break |
| [N/m²] | [N/mm] | [%] | [J] | [%] | [%] |

Reference damaged twice by CW

| | | | | | |
|---|---|---|---|---|---|
| 7.62E+08 | 3.53E−02 | 2.63E+00 | 4.38E−04 | 2.93E+01 | 5.61E+01 |

Example according to the invention damaged twice with CW and in between treated twice with catechol+DeniLiteBase+1-hydroxybenzotriazole

| | | | | | |
|---|---|---|---|---|---|
| 8.71E+08 | 3.93E−02 | 2.46E+00 | 4.70E−04 | 2.68E+01 | 5.12E+01 |

t-Test, in pairs, bilateral

| | | | | | |
|---|---|---|---|---|---|
| Extremely | Extremely | Tendentially | Tendentially | Extremely | Extremely |
| highly | highly | different | different | highly | highly |
| significantly | significantly | | | significantly | significantly |
| different | different | | | different | different |

### 3.7 Results of Catechol/Polyphenol Oxidase From the Fungus Melanocarpus Restructuring

Example according to the invention damaged hair, hair treated with catechol and enzyme solution, as described under 3.2: steps a), b), e) catechol, pH 6.5, f) AB-enzymes laccase 3, g); repetition of steps a), b), e) catechol, pH 6.5, f) polyphenol oxidase from the fungus Melanocarpus, g); i) in the wet state, j) in the wet state.

As a result of the treatment with catechol and polyphenol oxidase from the fungus Melanocarpus, all of the parameters are extremely highly significantly different. The stress values in the Hook's range are significantly higher and the elongation at break is lower than for the reference. The treatment with catechol and the polyphenol oxidase from the fungus Melanocarpus leads to a strengthening of the hair structure. The reduction in the hair cross-sectional area compared to the reference is also very noteworthy.

| | | | | | |
|---|---|---|---|---|---|
| Hair cross- | Modulus | Stress at | Stress at | Elongation | |
| sectional | of | 15% | 25% | at | Stress |
| area | elasticity | elongation | elongation | break | at break |
| [μm²] | [N/m²] | [N/μm²] | [N/μm²] | [%] | [N/μm²] |

Reference damaged twice by CW

| | | | | | |
|---|---|---|---|---|---|
| 4.27E+03 | 8.95E−08 | 2.82E−05 | 3.43E−05 | 5.72E+01 | 1.19E−04 |

Example according to the invention damaged twice with CW and in between treated twice with catechol+polyphenol oxidase from the fungus Melanocarpus

| | | | | | |
|---|---|---|---|---|---|
| 3.21E+03 | 1.16E+09 | 3.64E−05 | 4.43E−05 | 5.32E+01 | 1.48E−04 |

t-Test, in pairs, bilateral

| | | | | | |
|---|---|---|---|---|---|
| Extremely | Extremely | Extremely | Extremely | Extremely | Extremely |
| highly | highly | highly | highly | highly | highly |
| significantly | significantly | significantly | significantly | significantly | significantly |
| different | different | different | different | different | different |

### 3.8 Results of Catechol/Polyphenol Oxidase From the Fungus Melanocarpus Restructuring

Example according to the invention: damaged hair, hair treated with catechol and enzyme solution, as described under 3.2: steps a), b), e) 75 ml of catechol, pH 6.5, 2% strength f) 10 ml of polyphenol oxidase from the fungus Melanocarpus/25 ml of methyl syringate, g); repetition of steps a), b), e) catechol, pH 6.5, 2% strength f) 10 ml of polyphenol oxidase from the fungus Melanocarpus/25 ml of methyl syringate, g); i) in the wet state, j) in the wet state.

In this system, a significant reduction in the hair cross section is found. The stress and work values of the plateau range and the stress at break are significantly greater than for the reference. However, the elongation at break is not different. It is possible here to speak of a slight improvement in the hair structure.

| | | | | | |
|---|---|---|---|---|---|
| Hair cross- | Modulus | Stress at | Stress at | Stress at | Stress |
| sectional | of | plateau | 15% | 25% | at |
| area | elasticity | range | elongation | elongation | break |
| [μm²] | [N/m²] | [N/μm²] | [N/μm²] | [N/μm²] | [N/μm²] |

Reference damaged twice by CW

| | | | | | |
|---|---|---|---|---|---|
| 4.34E+03 | 9.73E+08 | 3.22E−05 | 3.12E−05 | 3.81E−05 | 1.30E−04 |

Example according to the invention damaged twice with CW and in between treated twice with catechol+polyphenol oxidase from the fungus Melanocarpus+methyl syringate

| | | | | | |
|---|---|---|---|---|---|
| 3.74E+03 | 1.11E+09 | 3.63E−05 | 3.46E−05 | 4.20E−05 | 1.52E−04 |

t-Test, in pairs, bilateral

| | | | | | |
|---|---|---|---|---|---|
| Extremely | Extremely | Extremely | Extremely | Extremely | Extremely |
| highly | highly | highly | highly | highly | highly |
| significantly | significantly | significantly | significantly | significantly | significantly |
| different | different | different | different | different | different |

### 3.9 Results of Catechol/Polyphenol Oxidase From the Fungus Thielavia Restructuring

Example according to the invention: damaged hair, hair treated with catechol and enzyme solution, as described under 3.2: steps a), b), e) catechol, pH 6.5, f) polyphenol oxidase from the fungus Thielavia, g); repetition of steps a), b), e) catechol, pH 6.5, f) polyphenol oxidase from the fungus Thielavia, g); i) in the wet state, j) in the wet state.

The treatment with catechol and the polyphenol oxidase from the fungus Thielavia leads to a significant improvement in the hair structure.

| | | | | | |
|---|---|---|---|---|---|
| Hair cross- | Modulus | Stress at | Stress at | Elongation | |
| sectional | of | 15% | 25% | at | Stress at |
| area | elasticity | elongation | elongation | break | break |
| [μm²] | [N/m²] | [N/μm²] | [N/μm²] | [%] | [N/μm²] |

Reference damaged twice by CW

| | | | | | |
|---|---|---|---|---|---|
| 4.23E+03 | 9.73E+08 | 3.04E−05 | 3.68E−05 | 6.04E+01 | 1.44E−04 |

Example according to the invention damaged twice with CW and in between treated twice with catechol+polyphenol oxidase from the fungus Thielavia

| | | | | | |
|---|---|---|---|---|---|
| 3.60E+03 | 1.21E+08 | 3.71E−05 | 4.53E−05 | 5.72E+01 | 1.69E−04 |

t-Test, in pairs, bilateral

| | | | | | |
|---|---|---|---|---|---|
| Extremely | Extremely | Extremely | Extremely | Extremely | Extremely |
| highly | highly | highly | highly | highly | highly |
| significantly | significantly | significantly | significantly | significantly | significantly |
| different | different | different | different | different | different |

### 3.10 Results of Restructuring by Plant Extracts on Bleached Hair Using the Example of Green Tea Extract Powder (Cosmetochem)/DeniLite

Bleaching and Treatment:

30 min application of an ultrableaching (6% H₂O₂, 15% (NH₄)₂S₂O₈, pH 9.4). The hair is then rinsed for 5 min with water.

Application of an aqueous solution of green tea extract powder from Cosmetochem (green tea Herbasec batch No. 1536180), (5% strength dissolved in Tris/HCl buffer, pH 6.5) at 32° C.

Addition of 10 ml of enzyme solution (in Tris/HCl buffer, pH 7.5) and treatment for a further 15 min at 32° C.

The hair is rinsed for 10 sec.

Measurement of the hair cross sections of the wet individual hairs.

Determination of the break values of the wet individual hairs.

As a reference, the first part of the hair is only bleached.

A significant increase in the stress and work values in the plastic range and the total work is found. A restructuring of bleached hair by the green tea (powder) and DeniLite system was thereby demonstrated.

| | | | | | | |
|---|---|---|---|---|---|---|
| | Plateau | Stress | Work at | Stress | Work at | |
| Elastic | range | at 15% | 15% | at 25% | 25% | |
| elongation | stress | elongation | elongation | elongation | elongation | Total work |
| [%] | [N/μm²] | [N/μm²] | [J] | [N/μm²] | [J] | [J] |

Reference damaged once by ultrableaching

| | | | | | | |
|---|---|---|---|---|---|---|
| 2.96E+00 | 6.25E−05 | 6.15E−05 | 8.21E−04 | 8.50E−05 | 1.67E−03 | 5.95E−03 |

Example according to the invention damaged by an ultrableaching and treated with green tea+DeniLite

| | | | | | | |
|---|---|---|---|---|---|---|
| 4.10E+00 | 8.69E−05 | 8.67E−05 | 1.09E−03 | 1.08E−04 | 2.21E−03 | 6.90E−03 |
| Extremely | Extremely | Extremely | Extremely | Extremely | Extremely | Extremely |
| highly | highly | highly | highly | highly | highly | highly |
| significantly | significantly | significantly | significantly | significantly | significantly | significantly |
| different | different | different | different | different | different | different |

### 3.11 Results of Restructuring on Dry Hair Using the Example of Catechol/DeniLiteBase

Example according to the invention: damaged hair, hair treated with catechol and enzyme solution, as described under 3.2: steps a), b), e) catechol, pH 6.5, f) DeniLiteBase, g), i) in the dry state, j) in the dry state.

As a result of the treatment with catechol and DeniLiteBase, the plastic elongation and the elongation at break is significantly increased, which is positive. From this arises a significant increase in the total work (area under the curve). In Hook's range, the modulus of elasticity and gradient are significantly increased, which is deemed to be positive. The significant increase in the hair cross-sectional area was confirmed here.

| | | | | | | |
|---|---|---|---|---|---|---|
| Hair Cross | Modulus | | | | Elongation | |
| sectional | of | Elastic | Elastic | Plastic | at | |
| area | elasticity | gradient | elongation | elongation | break | Total work |
| [μm²] | [N/m²] | [N/mm] | [%] | [%] | [%] | [J] |

Reference damaged once by CW

| | | | | | | |
|---|---|---|---|---|---|---|
| 3.21E+03 | 4.75E+09 | 4.94E−01 | 4.51E+00 | 2.42E+01 | 4.41E+01 | 1.08E−02 |

Example according to the invention damaged once by CW and then treated with catechol+DeniLiteBase

| | | | | | | |
|---|---|---|---|---|---|---|
| 3.38E+03 | 5.20E+09 | 5.73E−01 | 4.29E+00 | 2.66E+01 | 4.91E+01 | 1.24E−02 |
| | Extremely | Extremely | Extremely | Extremely | Extremely | Extremely |
| | highly | highly | highly | highly | highly | highly |
| Significantly | significantly | significantly | significantly | significantly | significantly | significantly |
| different | different | different | different | different | different | different |

### 4. Hair Thickening on Permanently Waved Hair

The hair cross-sectional area was determined by means of laser technology as described under 1.

### 4.1 Hair Treatment

40 individual hairs were used, the hair cross-sectional areas of which were determined before and after the treatment in the dry state (32° C. and 20% relative humidity) by means of laser technology, as described under 1., without destruction.

### 4.2 Results of Gallic Acid/DeniLite Hair Thickening

Example according to the invention gallic acid/DeniLite hair thickening, application as described under 3.2.

1st treatment: steps a), b), c), d) in the dry state, e) gallic acid, f) DeniLite, g) h) i) in the dry state.

2nd treatment: repetition of steps a), b), c), d) in the dry state, e) gallic acid, f) DeniLite, g) h) i) in the dry state.

Both during the first and also during the second treatment step is found a significant enlargement of the small and large axes of the hair and thus also of the hair cross-sectional area.

| | Small axis | Large axis | Area |
|---|---|---|---|
| | [μm] | [μm] | [μm²] |
| 1st cold wave | 52.5 | 77.8 | 2524.2 |
| 1st treatment | 53.3 | 79.4 | 2621.9 |
| t-Test, | extremely highly | extremely highly | tendentially |
| bilateral, in pairs | significantly | significantly | different |
| | different | different | |
| 2nd cold wave | 52.0 | 78.3 | 2479.6 |
| 2nd treatment | 53.2 | 79.6 | 2661.3 |
| t-Test, | extremely highly | extremely highly | tendentially |
| bilateral, in pairs | significantly | significantly | different |
| | different | different | |

### 4.3 Results of Catechol/Polyphenol Oxidase From the Fungus Thielavia Hair Thickening

Example according to the invention catechol/polyphenol oxidase from the fungus Thielavia hair thickening, application as described under 3.2.

Steps a), b), c), e) catechol, pH 6.5, f) polyphenol oxidase from the fungus Thielavia g); repetition of the steps a), b), c), e) catechol, pH 6.5, f) polyphenol oxidase from the fungus Thielavia, g) h) i) in the dry state.

The treatment with catechol and polyphenol oxidase from the fungus Thielavia on permanently waved hair leads to a clear increase in the hair cross-sectional area.

| Catechol + | | | |
|---|---|---|---|
| polyphenol | | | |
| oxidase | | | |
| from the fungus | | | |
| Thielavia on | Small axis | Large axis | Area |
| twice-permed hair | [μm] | [μm] | [μm²] |
| 2nd cold wave | 54.9 | 83.2 | 2776.5 |
| 2nd treatment | 56.3 | 84.2 | 2930.9 |
| t-Test, bilateral, | not different | not different | significantly |
| in pairs | | | different |

### 4.4 Results of Hair Thickening By Plant Extracts and DeniLite

The is determined by means of laser technology as described under 1.

Solutions used:

1. Grape seed extract (standardized grape seed extract C3134, lot No. RM 38360, Carrubba Inc.), 1% strength in water; pH 6.1

2. Chardonnay extract (Art. No. 21646, Crodarom); 0.5% strength in water; pH 6.5

3. DeniLite enzyme slurry in Tris/HCl buffer; diluted 1:20; pH 6.5

4. Cold wave: 7% TGA, 0.3% Turpinal SL, 3.5% (NH₄)₂CO₃, pH 8.4

5. Neutralizer: 2% H₂O₂, 1% Turpinal SL, pH 4.0

Hair Treatment:

1. Application of the cold wave for 30 minutes. The hair is then rinsed for 5 minutes.

2. Application of the neutralizer for 10 minutes. The hair is then rinsed for 5 minutes.

3. Treatment for 15 minutes with the plant extract solution at 32° C.

4. Addition of 10 ml of enzyme solution and treatment for a further 15 min.

5. The hair is rinsed for 10 sec.

6. Conditioning of the hair at 32° C. and <20% relative humidity. Measurement of the hair cross sections of the dry individual hairs.

Results of the thickness measurement:

| Grape seed | Small axis | Large axis | Area |
|---|---|---|---|
| extract | [μm] | [μm] | [μm²] |
| 1st cold wave | 57.6 | 83.9 | 3033.7 |
| 1st treatment | 73.6 | 152.1 | 6199.9 |
| t-Test, | extremely highly | extremely highly | extremely highly |
| bilateral, in | significantly | significantly | significantly |
| pairs | different | different | different |

| Chardonnay | Small axis | Large axis | Area |
|---|---|---|---|
| extract | [μm] | [μm] | [μm²] |
| 1st cold wave | 57.3 | 84.3 | 3001.9 |
| 1st treatment | 70.0 | 94.2 | 3977.6 |
| t-Test, | extremely highly | extremely highly | extremely |
| bilateral, in | significantly | significantly | highly |
| pairs | different | different | significantly |
| | | | different |

### SUMMARY

The grape seed extract and the chardonnay extract lead to a significant increase in the hair cross-sectional area. Both extracts lead to a visible film on the hair, which is no longer tacky after drying.

### 5. Hair Thickening on Bleached Hair

The is determined by means of laser technology as described under 1.

### 5.1 Hair Treatment

40 individual hairs were used whose hair cross-sectional areas were determined before and after the treatment in the dry state (32° C. and 20% relative humidity) by means of laser technology, as described under 1., without destruction.

### 5.2 Application of the Solutions

a) 30 min application of an ultrableaching (6% H₂O₂, 15% (NH₄)₂S₂O₈, pH 9.4). The hair is then rinsed with water for 5 minutes.

b) 17 h conditioning of the hair at 32° C. and 20% relative humidity.

c) Measurement of the hair cross sections of the dry individual hairs.

d) Treatment for 15 min with aqueous catechol solution (2% strength dissolved in Tris/HCl buffer, pH 6.5) at 32° C.

e) Addition of 10 ml of enzyme solution (in Tris/HCl buffer, pH 7.5) and treatment for a further 15 min at 32° C.

f) The hairs are rinsed with water for 10 sec.

g) Conditioning of the hair for 17 h at 32° C. and 20% relative humidity.

h) Measurement of the hair cross sections of the dry individual hairs.

### 5.3 Results of Catechol/Polyphenol Oxidase From the Fungus Thielavia Hair Thickening

Example according to the invention catechol/polyphenol oxidase from the fungus Thielavia hair thickening, application as described under 5.2.

The treatment with catechol and polyphenol oxidase from the fungus Thielavia leads, in the case of bleached hair, to a significant increase in the small and large axes, and also the hair cross-sectional area resulting therefrom.

| Catechol + | | | |
|---|---|---|---|
| polyphenol | | | |
| oxidase from | | | |
| the fungus | | | |
| Thielavia on | Small axis | Large axis | Area |
| bleached hair | [μm] | [μm] | [μm²] |
| Bleaching | 57.1 | 85.1 | 2991.4 |
| 1st treatment | 58.0 | 86.6 | 3121.8 |
| t-Test, | extremely highly | extremely | extremely |
| bilateral, in | significantly | highly | highly |
| pairs | different | significantly | significantly |
| | | different | different |

### 6. Determination of a Conditioning Effect

### 6.1 Determination of the Wet Combability

### 6.1.1 Treatment of the Hair

1. Cleansing of the hair tresses with 10% strength Na lauryl ether sulfate solution in an ultrasound bath, 15 min, then rinsing for 10 min.

2. Measure combability blank value

3. Permanent wave for 30 min (7% TGA, pH 8.4), rinsing for 5 min, 10 min neutralizing (2% H₂O₂), 5 min rinsing

4. Measure combability

5. Treatment of the hair tresses with 2% strength catechol solution (immersion bath), 15 min

6. Rinsing for 5 s in combing apparatus+rinsing for 16 s prior to the measurement

7. Measure combability

8. Treatment of the hair tresses with 2% strength catechol solution (immersion bath), 15 min

9. Admixing of the 2% strength DeniLiteBase solution to the catechol solution (10 ml per 75 ml of catechol solution) and further treatment of the hair tresses (immersion bath), 15 min

10. Rinsing for 5 s in combing apparatus+rinsing for 16 s prior to the measurement

11. Measure combability

### 6.1.2 Results for wet combability:

(A) Untreated hair+cleansed (blank value)

(B) Untreated hair+cleansed+1×permanent wave

(C) Untreated hair+cleansed+1×permanent wave+2% catechol solution

(D) Untreated hair+cleansed+1×permanent wave+2% strength catechol solution+2% strength catechol solution/DeniLiteBase

By determining the wet combability, it was demonstrated that an aftertreatment with catechol/DeniLiteBase leads to a reduction in the combabilities. A treatment only with catechol does not exhibit this effect.

| | | Wet | | |
|---|---|---|---|---|
| | Wet combing | combing | | |
| | work | work | | Significance |
| | before | after | Remainder | before/after |
| Formulation used | [mJ] | [mJ] | [%] | [%] |
| Untreated hair + | — | 165 | — | — |
| cleansed | | | | |
| (blank | | | | |
| value) | | | | |
| Untreated hair + | 165 | 194 | 118 | 99 |
| cleansed + 1x | | | | |
| permanent wave | | | | |
| Untreated hair + | 194 | 194 | 100 | no |
| cleansed + 1x | | | | difference |
| permanent | | | | |
| wave + 2% | | | | |
| strength catechol | | | | |
| solution | | | | |
| Untreated hair + | 194 | 174 | 90 | 95 |
| cleansed + 1x | | | | |
| permanent | | | | |
| wave + 2% | | | | |
| stength catechol | | | | |
| solution + 2% | | | | |
| strength catechol | | | | |
| solution/ | | | | |
| DeniLiteBase | | | | |

### 6.2 Determination of the Dry Combability

### 6.2.1 Treatment of the Hair

1. Cleansing of the hair tresses with 10% stength Na lauryl ether sulfate solution in an ultrasound bath, 15 min, then rinsing for 10 min.

2. Climatization of the hair, 24 hours at 23° C. and 25% relative atmospheric humidity

3. Measure combability blank value

4. Permanent wave for 30 min (7% TGA, pH 8.4), rinsing for

5 min, neutralizing for 10 min (2% H₂O₂) rinsing for 5 min

5. Climatization of the hair, 24 hours at 23° C. and 25% relative atmospheric humidity

6. Measure combability

7. a) treatment of the hair tresses with 2% strength catechol solution (immersion bath), 15 min or

b) treatment of the hair tresses with 2% strength catechol solution (immersion bath), 15 min/admixing of the 2% strength DeniLiteBase solution to the catechol solution (10 ml per 75 ml of catechol solution) and further treatment of the hair tresses (immersion bath), 15 min

8. Rinsing for 10 s in a combing apparatus

9. Climatization of the hair, 24 hours at 23° C. and 25% relative atmospheric humidity

10. Measure combability

### 6.2.2 Results of Dry Combability:

(E) Untreated hair+cleansed (blank value)

(F) Untreated hair+cleansed+1×permanent wave

(G) Untreated hair+cleansed+1×permanent wave+2% strength catechol solution

(H) Untreated hair+cleansed+1×permanent wave+2% strength catechol solution/DeniLiteBase

By determining the dry combability, it was demonstrated that an aftertreatment with catechol/DeniLiteBase leads to a reduction in the combabilities. A treatment only with catechol does not exhibit this effect.

Dry combability, only catechol treatment

| | Dry combing | Dry combing | | Significance |
|---|---|---|---|---|
| | work before | work after | Remainder | before/after |
| Formulation used | [mNm] | [mNm] | [%] | [%] |
| Untreated hair + | — | 29 | — | — |
| cleansed | | | | |
| (blank | | | | |
| value) | | | | |
| Untreated hair + | 29 | 31 | 107 | 62 |
| cleansed + 1x | | | | |
| permanent wave | | | | |
| Untreated hair + | 31 | 39 | 126 | 96 |
| cleansed + 1x | | | | |
| permanent | | | | |
| wave + 2% | | | | |
| strength | | | | |
| catechol solution | | | | |

Dry combability, catechol/DeniLiteBase treatment

| | Dry combing | Dry combing | | Significance |
|---|---|---|---|---|
| | work before | work after | Remainder | before/after |
| Formulation used | [mNm] | [mNm] | [%] | [%] |
| Untreated hair + | — | 23 | — | — |
| cleansed | | | | |
| (blank | | | | |
| value) | | | | |
| Untreated hair + | 23 | 28 | 122 | >99 |
| cleansed + 1x | | | | |
| permanent wave | | | | |
| Untreated hair + | 28 | 26 | 93 | 62 |
| cleansed + 1x | | | | |
| permanent | | | | |
| wave + 2% | | | | |
| strength | | | | |
| catechol | | | | |
| solution/DeniLite | | | | |
| Base | | | | |

### 7. Increase in the Washing Resistance of Colored Hair (Color Run Protection)

To test the increase in the washing resistance of colored hair after repeated shampooing, adhesive tresses (double-sided, extra tight, of selected white EN hair, 2 cm adhesive edge top and bottom, 6 cm free hair, 2 cm adhesive tress corresponds to 1 g of hair) were colored by applying polyphenol/polyphenol oxidase, treated with polyphenol/polyphenol oxidase, shampooed and measured by means of colorimetry.

### 7.1 Measurement Methods

Determination of the CIE L*a*b*(C*h^{o}ab) values in accordance with DIN 5033, Part 3 using the Minolta calorimeter Cr 310-6. The front and back of the tresses were measured in each case five times using a 50 mm measuring diaphragm.

### 7.2 Hair Treatment

1. Two of the abovementioned hair tresses (each 16 cm in length) were treated for 30 minutes with 100 ml of a shampoo solution per tress, then rinsed with water for 5 minutes and dried for 2 h at 40° C. in a circulating air drying cabinet.

2. Both tresses were colored with 35 g of a coloring cream (Poly Brilliance No. 872 color shade Intensive Red, hair colorant from Henkel Schwarzkopf) for 30 minutes at 32° C., then rinsed thoroughly and then dried for 2 h at 40° C. in a circulating air drying cabinet.

3. A tress was treated with 75 ml of a catechol solution (2% strength dissolved in Tris/HCl buffer, pH 6.5) at 32° C. for 15 minutes. Then addition of 10 ml of enzyme solution (DeniLiteBase enzyme slurry in Tris/HCl buffer; diluted 1:20; pH 6.5) and treatment for a further 15 min at 32° C. The second tress was treated analogously with 75 ml of demin. water for 15 min at 32° C. and then treated for a further 15 min at 32° C. with 10 ml of demin. water.

4. Rinsing for 1 minute.

5. Drying for 2 h at 40 degrees in a circulating air drying cabinet.

6. Starting value

7. 1st shampooing (12% Texapon NSO, pH 6.5) 75 ml/tress, contact time 5 minutes, rinse time 2 minutes and 2 h drying at 40° C. in circulating air.

8. Repetition of the point Nos. 3 to 5.

9. 1st color measurement

10. Repetition of the point Nos. 3, 4, 5, 7.

11. 2nd color measurement

12. Repetition of the point Nos. 3, 4,5, 7.

13. 3rd color measurement

14. Repetition of the point Nos. 3, 4, 5, 7.

15. 4th color measurement

16. Repetition of the point Nos. 3, 4, 5, 7.

17. 5th color measurement

### 7.3 Evaluation

During the color measurement, the Cartesian coordinates L*a*b* were determined. Each tress was measured at 10 points and the average values were taken. From these values were calculated the polar coordinates C* for the chroma and h^{o}_{ab} for the hue angle. In addition, the overall color difference ΔE*_{ab} between the treated and the untreated tress was used for the evaluation.

### 7.4 Results

The hair tress treated according to the invention is less considerably lightened after all five shampoo treatments since it in each case has smaller L* values. For the assessment in the color axes red/green and yellow/blue, the tress treated according to the invention likewise exhibits a significantly lesser color change through smaller differences (in each case ΔL*, Δa*, Δb* values of the shampooed value minus the untreated starting value in each case). This finding is further confirmed by the polar coordinates C* for the chroma. The evaluation of the total color difference ΔE* (treated minus untreated) between the two tresses likewise gives significant color difference features (e.g. after 5 shampooings 3.38 units). In subjective terms, this colorimetric finding can likewise be perceived very clearly, the red color of the hair tress not treated according to the invention is evaluated as being less intensively washed out, or as being more considerably washed out, in the direction of pale red. Comparison of the hair tresses before the shampooings reveals a small color shift between the two color tresses (starting value). This color shift, which is caused by the treatment according to the invention, whilst capable of being measured, can not be seen by the naked eye, and is therefore of no practical relevance. It is noteworthy that the tress treated according to the invention has virtually identical L,a,b values even after 5 shampooings (column furthest right) as the unwashed tress not treated in accordance with the invention (column furthest left).

| | Starting | | | | | | | | | | | |
|---|---|---|---|---|---|---|---|---|---|---|---|---|
| | value | | 1x | | 2x | | 3x | | 4x | | 5x | |
| | (1) | (2) | (1) | (2) | (1) | (2) | (1) | (2) | (1) | (2) | (1) | (2) |
| L* value | 23.04 | 21.91 | 23.68 | 22.63 | 24.82 | 23.12 | 24.95 | 23.34 | 25.34 | 23.23 | 25.41 | 23.12 |
| (lightness) | | | | | | | | | | | | |
| a* value | 14.89 | 13.64 | 15.91 | 14.11 | 16.19 | 14.13 | 16.18 | 14.05 | 16.11 | 13.65 | 16.15 | 14.13 |
| (+red/−green) | | | | | | | | | | | | |
| b* value | 6.95 | 5.90 | 7.58 | 6.53 | 8.03 | 6.69 | 8.25 | 6.86 | 8.49 | 6.66 | 8.64 | 6.69 |
| (+yellow/−blue) | | | | | | | | | | | | |
| h°_{ab} | 25.03 | 23.39 | 25.47 | 24.84 | 26.38 | 25.35 | 27.01 | 26.00 | 27.78 | 5.99 | 28.13 | 25.35 |
| (hue angle 0-360°) | | | | | | | | | | | | |
| C*ab | 16.43 | 14.86 | 17.62 | 15.54 | 18.08 | 15.63 | 18.16 | 15.64 | 18.21 | 15.19 | 18.32 | 15.63 |
| (chroma) | | | | | | | | | | | | |
| ΔE*_{ab} | | 1.99 | | 2.34 | | 2.99 | | 3.01 | | 3.72 | | 3.38 |

(1) = untreated,
(2) = treated

### 8. Wool

### 8.1 Measurement Method

Determination of the dry yarn breaking strength of wool yarn using the Statimat M from Textechno at 65% relative atmospheric humidity and 20° C.

### 8.2 Wool Yarn Used

Double yarn of grade Nm 20/2 S111 from Süd Wolle AG.

### 8.3 Effect of the Treatment With Catechol/DeniLiteBase on Untreated Wool, Fiber Strengthening

### 8.3.1 Treatment Conditions

100 m of the abovementioned wool yarn were wound onto a special spool and treated at 32° C. with 375 ml of catechol solution (2% strength; dissolved in Tris/HCl buffer, pH 6.5) on the spool for 15 minutes. Afterward, addition of 50 ml of the enzyme solution (DeniLiteBase enzyme slurry in Tris/HCl buffer; diluted 1:20; pH 6.5) and further treatment for 15 minutes at 32° C. 1 minute rinsing at about 30° C. with process water. 2 hours drying at 30° C. in a circulating air drying cabinet. Afterward, drying and/or conditioning for 2 days at 20° C. and 65% relative atmospheric humidity. As reference, wool yarn was treated in an analogous manner with process water for 30 minutes.

### 8.3.2 Results

The determination of the fineness of the treated wool yarn, and of the reference was 1014 dtex, i.e. 10 000 m of the treated yarn weighed 1014 g. The treatment of the untreated wool yarn with catechol and DeniLiteBase leads, compared to the water treatment, to an increase in the maximum tensile force and/or the maximum tenacity, the force at 5% elongation and the modulus between 1 and 4% elongation. The increase in these four parameters can be evaluated as “yarn strengthening or consolidation”.

| | | | | | |
|---|---|---|---|---|---|
| Modulus | | | | | |
| between | | | Maximum | | |
| 1 and 4% | Force at 5% | Elongation | tensile | | Work to |
| elongation | elongation | at break | force | Tenacity | break |
| [cN/dtex] | [cN] | [%] | [cN] | [cN/dtex] | [cN/cm] |

Wool treated with process water:

| | | | | | |
|---|---|---|---|---|---|
| 10.86 | 515.84 | 34.14 | 799.69 | 0.79 | 10558.01 |

Wool treated with catechol/DeniLiteBase:

| | | | | | |
|---|---|---|---|---|---|
| 11.33 | 538.20 | 34.06 | 825.30 | 0.81 | 10741.50 |

t-Test for bilateral, independent average comparison
Wool treated with water to wool treated with
catechol/DeniLiteBase:

| | | | | | |
|---|---|---|---|---|---|
| Extremely | Extremely | Not different | Extremely | Extremely | Not different |
| highly | highly | | highly | highly | |
| significantly | significantly | | significantly | significantly | |
| different | different | | different | different | |

### 8.4 Effect of the Treatment With Catechol/DeniLiteBase on Untreated Wool, Light Protection Effect

### 8.4.1 Treatment Conditions

Initially, about 17 m of the untreated abovementioned wool yarn were irradiated with daylight on a special spool in a defined way. The radiation was produced using a Suntest CPS+accelerated-exposure bench instrument from Atlas. The irradiation time was 4 days at an irradiation intensity of 500 watt/m² which corresponds to 1800 KJ/h/m². The irradiation chamber had a black standard temperature of 50 degrees Celsius. In order to ascertain any possible effect of the temperature on the wool, 100 m of wool yarn were exposed for just 4 days to a temperature of 50 degrees Celsius in a circulating air drying cabinet. In two further experiments, a wool yarn sample 17 m in length was in each case treated with water or with catechol/DeniLiteBase. The treatment conditions were analogous to those described under 8.3.1. The wool yarn samples treated in this way irradiated as described above. The dry yarn breaking strength was determined for all of the wool samples.

### 8.4.2 Results

In contrast to the untreated wool yarn, the four-day exposure to light leads to a significant change in the yarn stress-strain properties. All of the specific parameters are lowered, i.e. the wool yarn is considerably weakened in its breaking strength. An “embrittling” of the yarn is evident from a lower elongation at break. The four-day exposure to a temperature of 50 degrees Celsius exhibits no significant influence on the yarn stress-strain properties. A treatment of the wool yarn with catechol and DeniLiteBase and subsequent irradiation lead, compared to the reference (water treatment), to highly significantly less wool yarn weakening. The catechol and DeniLiteBase system thus exhibits a clear photoprotective effect. The Tris/HCl buffer on its own, and the water treatment or treatment of catechol without enzyme solution have no effect with regard to light protection.

| | | | | | | |
|---|---|---|---|---|---|---|
| Modulus | | | | | | |
| between 1 | Force at | Elongation | Maximum | | | |
| and 4% | 5% | at | tensile | | Work at | |
| elongation | elongation | break | force | Tenacity | break | Fineness |
| [cN/dtex] | [cN] | [%] | [cN] | [cN/dtex] | [cN/cm] | [dtex] |

Untreated wool:

| | | | | | | |
|---|---|---|---|---|---|---|
| 13.49 | 597.91 | 29.20 | 795.79 | 0.82 | 9484.91 | 976 |

Untreated wool irradiated for 4 days

| | | | | | | |
|---|---|---|---|---|---|---|
| 12.59 | 576.29 | 25.06 | 713.43 | 0.72 | 7451.25 | 987 |

t-Test for bilateral, independent average comparison:

| | | | | | |
|---|---|---|---|---|---|
| Extremely | Extremely | Extremely | Extremely | Extremely | Extremely |
| highly | highly | highly | highly | highly | highly |
| significantly | significantly | significantly | significantly | significantly | significantly |
| different | different | different | different | different | different |

Untreated wool

| | | | | | | |
|---|---|---|---|---|---|---|
| 12.97 | 586.80 | 28.51 | 783.03 | 0.79 | 9199.45 | 988 |

Untreated wool conditioned for 4 days at an air temperature of 50
degrees Celsius

| | | | | | | |
|---|---|---|---|---|---|---|
| 12.77 | 575.31 | 29.96 | 789.12 | 0.81 | 9557.15 | 972 |

t-Test for bilateral, independent average comparison:

| | | | | | |
|---|---|---|---|---|---|
| Not | Not | not | not | not | not |
| different | different | different | different | different | different |

Wool treated with water and irradiated for 4 days:

| | | | | | | |
|---|---|---|---|---|---|---|
| 11.62 | 534.84 | 27.34 | 714.67 | 0.72 | 8015.61 | 991 |

Wool treated with catechol/DeniLiteBase and irradiated for 4 days:

| | | | | | | |
|---|---|---|---|---|---|---|
| 12.01 | 584.58 | 32.74 | 821.23 | 0.81 | 10669.06 | 1013 |

t-Test for bilateral, independent average comparison:

| | | | | | |
|---|---|---|---|---|---|
| | Extremely | Extremely | Extremely | Extremely | Extremely |
| | highly | highly | highly | highly | highly |
| significantly | significantly | significantly | significantly | significantly | significantly |
| different | different | different | different | different | different |

What is claimed is:

1. A method for modifying keratin fibers comprising polymerizing phenolic, arylaminic, enolic and/or enaminic substrates by use of polyphenol oxidases as polymerization agents.

2. The method of claim 1 wherein the substrates carry up to 5 substituents, said substituents selected, independently of one another, from the group consisting of
a) a hydroxyl group;
b) aldehyde, keto and carboxyl groups,
c) alkoxy groups having 1 to 6 carbon atoms;
d) primary, secondary, tertiary amino groups, or ammonium salts thereof;
e) halogen groups, such as fluorine, chlorine, bromine and iodine,
f) branched and unbranched C₁ to C₆-alkyl and alkylene groups which additionally may have the groups specified under a)-e) as substituents and
g) mono- or polysaccharide groups which may be joined to phenolic compounds via ether or ester bonds with carbohydrates.

3. The method of claim 1 wherein the phenolic substrates are chosen from the group consisting of phenyl, hydroquinone, pyrocatechin, resorcinol, phloroglucinol, mono-, di- or trihydroxybenzaldehydes, aminohydroxybenzaldehydes, vanillin, syringa aldehyde, mono-, di- or trihydroxybenzoic acid, 2,3-, 3,4-, 2,5-dihydroxybenzoic acid, salicylic acid, syringa acid, vanillic acid, gallic acid, 2,6-dimethoxyphenol, 4-allyl-2-methoxyphenol, eugenol, 3,4-dihydroxycinnamic acid, biphenyls or polyphenolic compounds whose aromatic rings may be joined via aliphatic groups, azo compounds, aldazines, tannins and turgorinic acid, 3-methylcatechol, 4-methylcatechol, 4-nitrocatechol, catechin, 1-catechin, d-catechin, caffeic acid, hydrocaffeic acid, gallic acid, L-tyrosine, shikimic acid, quercetin, 2,4-dichloro-3-aminophenol, rutin, N-acetyl-6-hydroxytryptophan, tryptophan, L-epicatechol, DL-epicatechol, epicatechol gallate, p-coumaric acid, heliogenol, lignin, lignosulfonic acid, humic acid, nitrohumic acid, tannin, urushiol, 4-hydroxycinnamyl alcohol, o-coumaric acid, p-coumaric acid, coniferyl alcohol, coniferyl aldehyde, ferulic acid, ethyl-3,4-dihydroxycinnamic acid, 3-hydroxy-4-methoxycinnamic acid, 3,4-dihydroxycinnamic acid, 3-hydroxy-4-methoxycinnamaldehyde, vanillin, o-vanillin, vanillic acid, vanillyl alcohol, o-vanillyl alcohol, isovanillyl alcohol, vanillylamine, vinillylazines, 4-hydroxy-3-methoxybenzonitrile, syringa acid, sinapyl alcohol, sinapic acid, sinapinaldehyde, homovanillic acid, homovanillyl alcohol, homovanillonitrile, hesperidin, chlorogenic acid, hinokitiol, pyrocatechol, hydroquinone, tert-butylhydroquinone, phenylhydroquinone, trimethylhydroquinone, pyrogallol, lauryl gallate, octyl gallate, 3,4-dihydroxybenzoic acid, 1,2-dihydroxynaphthalene, 2,3-dihydroxynaphthalene, o-hydroxybenzoic acid, p-hydroxybenzoic acid, 4-methoxyphenol, 2,5-dihydroxy-1,4-benzoquinone, 2,5-dihydroxybenzoic acid, methylhydroquinone, ethylhydroquinone, 1-hydroxybenzotriazoles, 2,3-dihydroxypyridazine, 3,6-dihydroxypyridazine, 2,3-, 3,4-, 3,5-, 2,4-dihydroxypyridine, 3,4-dimethoxystyrene, (3,4-dimethoxyphenyl)acetic acid, (3,4-dimethoxyphenyl)acetonitrile, (3,4-dimethoxy-phenyl)acetone, 3-(3,4-dimethoxyphenyl)propionic acid, 3-(3,4-dimethoxyphenyl)propanol, 4-(3,4-di-methoxyphenyl)butyric acid, 3-(3,4-dimethoxy-phenyl)propanol, 2-methoxy-4-propenylphenol, 3-(3,4-dihydroxyphenyl)-L-alanine, veratraldehyde, veratric acid, veratrol, homoveratric acid, 2′,5′-dimethoxyacetophenone, 3′,4′-dimethoxyacetophenones, 3,4-dimethoxycinnamic acid, 3,4-dimethoxycinnamonitrile, 2,3-dimethoxyphenol, 3,4-dimethoxyphenol, 3,4-dimethoxybenzyl alcohol, 2,3-dimethoxybenzoic acid, 2,5-dimethoxybenzoic acid, 1,4-dimethoxybenzene, 3-methoxysalicylic acid, acetylsalicylic acid, methyl salicylate, ethyl salicylate, methyl gallate, bisphenol, bilirubin, propyl gallate, 3,4,5-trimethoxyphenol, tropolone, purpurogallin, salicylaldoximes, 3-amino-5,6,7,8-tetrahydro-2-naphthol, 1,5-dihydroxynaphthalene, 3,5-dihydroxy-2-naphthenic acid, 4-hydroxy-1-naphthalenesulfonic acid, purpurin, 2,3-dihydro-9,10-dihydroxy-1,4-anthracenedione, epinephrine, pyrogallic acid, methyl-4-hydroxy-3-methoxybenzoic acid, 6,7-dihydroxy-2-naphthalenesulfonic acid, anthrarobin, alizarin, quinizarin, phloroglucinol, hydroquinone mono-methyl ether, N-methylcoclaurine, tannic acid, N-acetyldopamine. (N-acetyldopamine quinone), dopamine, N-formyl-L-tyrosine, tyramine (o-dihydroxybenzene), pyrogallol, alpha-methyldopaquinone, adrenaline bitartrate, trans-p-hydroxycinnamic acid, phloridzin, 3-hydroxyphloridzin, L-adrenaline, protocatechuric acid, 4-dihydroxybenzoic acid, esculetin, noradrenaline, epigallocatechin gallate, p-cresol, ferulic acid, sinapic acid, d-catechin, clorogenic acid, (R)-coclaurine, 2-naphthol, 1-naphthol, p-methoxyphenol, 2,6-dimethoxyphenol, o,m,p-chlorophenol, 2,4-dichlorophenol, 2,6-dichlorophenol, 2,6-di-methylphenol, phenol, 4-chloro-2-methylphenol, p-aminophenol, ferrocyanide, dopa, pyrocatechin, o,m,p-cresol, resorcinol, pyrazolones, 3,5-di-methoxyhydroxybenzaldazine, benzosemiquinone, 1,2,4-benzenetriol, (S)-coclaurine, L-tyrosine, phloroglucinol, 1,5-, 2,7- and 1,7-dihydroxynaphthaline, resorcinol monomethyl ether, hydroquinone monomethyl ether, N-methylcoclaurine, (R)-coclaurine, 4-chlororesorcinol, 2-chloro-6-methyl-3-aminophenol, (S)-coclaurine, 1,3-bis(2,4-diaminophenoxy)propane, 2-methylresorcinol, 5-methylresorcinol, 2,5-dimethylresorcinol, 2,6-dihydroxypyridine, o-phenylenediamine, 1,5-, 2,7- and 1,7-dihydroxynaphthalene, m-aminophenol, resorcinol, resorcinol monomethyl ether, 2-methylresorcinol, 5-methylresorcinol, 2-chlororesorcinol, 4-chlororesorcinol, 1-phenyl-3-methylpyrazol-5-one, 5-amino-2-methylphenol, 3,4-diaminobenzophenone, o-anisidine, p-anisidine, o-aminophenol, p-aminophenol, 1,3-bis(2,4-diaminophenoxy)propane, 2-methyl-4-chloro-5-aminophenol, 1,2-diaminoanthraquinone, 1,4-diaminoanthraquinone, 2,3,4-trihydroxybenzaldehyde, 3-(2,4)-, 3-(2,3)-, 3-(3,5)-, 3-(2,6)- and (3,4-dihydroxyphenyl)alanine, anthocyanides, proanthocyanides, flavones and catechins, and derivatives thereof.

4. The method of claim 1 wherein the enolic substrates are chosen from the group consisting of ascorbic acid, isoascorbic acid, 3,4-dihydroxy-3-cyclobutene-1,2-dione, morpholinocyclopent-1-ene, morpholinocyclohex-1-ene, 1-hydroxycyclohexene.

5. The method of claim 1 wherein the enaminic substrates are chosen from the group consisting of pyrrolidinocyclopent-1-ene, pyrrolidinocyclohex-1-ene, piperidinocyclohex-1-ene, ethyl β-aminocrotonate, ethyl β-methylaminocrotonate, ethyl β-dimethylaminocrotonate, ethyl β-anilinocrotonate, β-benzylaminocrotonic ester, ethyl β-benzylaminocrotonate, 4-aminopent-3-en-2-one, 4-benzylaminopent-3-en-2-one, 1-cyclopentene-1-amine, 1,4-cyclopentadiene-1-amine.

6. The method of claim 1 wherein the arylaminic substrates are chosen from the group consisting of aromatic amines which have at least one further functional group which is chosen from
a) an hydroxyl group;
b) aldehyde, keto and carboxyl groups;
c) alkoxy groups having 1 to 6 carbon atoms;
d) primary, secondary, tertiary amino groups, or ammonium salts thereof;
e) halogen groups such as fluorine, chlorine, bromine and iodine;
f) branched and unbranched C₁ to C₆-alkyl and alkylene groups which may additionally have the groups specified under a)-e) as substituents and
g) mono- or polysaccharide groups which may be linked to phenolic compounds via ether or ester bonds with carbohydrates.

7. The method of claim 6 wherein the arylaminic substrates are chosen from the group consisting of diaminopyridine derivatives, heterocyclic hydrazones, 4-aminopyrazolone derivatives, 2,4,5,6-tetramino-pyrimidine and derivatives thereof, p-phenylenediamine, p-toluylenediamine, 2,4,5,6-tetraminopyrimidine, p-aminophenol, N,N-bis(2-hydroxyethyl)-p-phenylenediamine, m-phenylenediamine, 2-(2,5-diaminophenyl)ethanol, 2-(2,5-diaminophenoxy)ethanol, 1-phenyl-3-carboxyamido-4-aminopyrazol-5-one, p-phenylenediamine, 4-amino-3-methylphenol, 2-aminomethyl-4-aminophenol, 2-hydroxy-4,5,6-triaminopyrimidine, 2,4-dihydroxy-5,6-diaminopyrimi-dine, 2,5,6-triamino-4-hydroxypyrimidine, 4,4′-ethylenedianiline, 4,5-diamino-6-hydroxy-2-mercaptopyrimidine, 2,3-diaminopyridine, 6-hydroxy-2,4,5-triaminopyrimidine, 4,5,6-triaminopyrimidine, ABTS (2,2′-azobis(3-ethylbenzothiazoline-6-sulfonic acid), 2-amino-3-hydroxypyridine, 3-amino-2-methoxybenzofuran, 2,4-dimethoxyanilines, 2,5-dimethoxyaniline, 3,4-dimethoxyaniline, veratrylamine, homoveratrylamine, homoveratronitrile, 3,4-dimethoxyphenethylamine, 2-methoxy-5-methylaniline, 2-methoxy-5-nitroaniline, 4-methoxy-2-nitroaniline, 3,4,5-trimethoxyaniline, p-phenylenediamine, 4,5-dimethyl-o-phenylenediamine, 4-amino-N,N′-dimethylaniline and m-aminophenols, p-phenylenediamine, p-toluylenediamine, p-aminophenol, 1-(2′-hydroxyethyl)-2,5-diaminobenzene, N,N-bis(2-hydroxyethyl)-p-phenylenediamine, 2-(2,5-diaminophenoxy)ethanol, 1-phenyl-3-carboxyamido-4-aminopyrazol-5-one, 4-amino-3-methylphenol, 2-methylamino-4-aminophenol, 2,4,5,6-tetraminopyrimidine, 2-hydroxy-4,5,6-triaminopyrimidine, 4-hydroxy-2,5,6-triaminopyrimidine, 2,4-dihydroxy-5,6-diaminopyrimidine, 2-dimethylamino-4,5,6-tri-aminopyrimidine, 2-hydroxyethylaminomethyl-4-aminophenol, 4,4′-diaminodiphenylamine, o-aminophenol, 5-amino-2-methylphenol, m-aminophenol, m-phenylenediamine, 1-phenyl-3-methylpyrazol-5-one, 2,4-dichloro-3-aminophenol, 2,6-diaminopyridine, 2-amino-3-hydroxypyridine, 2,6-dihydroxy-3,4-diaminopyridine, 3-amino-2-methylamino-6-methoxypyridine, 4-amino-2-hydroxytoluene, 2,6-bis(2-hydroxyethylamino)toluene, 2,4-diaminophenoxyethanol, 2-amino-4-hydroxyethylaminoanisole and 1,3-N,N′-bis(2′-hydroxyethyl)-N,N′-bis(4′-amino-phenyl)diaminopropan-2-ol.

8. The method of claim 1 wherein the polyphenol oxidases are chosen from the group consisting of laccases E.C.[1.10.3.2], catechol oxidases E.C.[1.10.3.1], ascorbate oxidases E.C.[1.10.3.3], tyrosinases E.C.[1.14.8.1] and bilirubin oxidases E.C.[1.3.3.5] or combinations thereof, and in particular from polyphenol oxidases from the fungi Trametes, Myceliophthora, Melanocarpus and Thielavia or combinations thereof.

9. The method of claim 1 further comprising at least one suitable mediator.

10. The method of claim 9 wherein the mediator is chosen from the group consisting of hydroxybenzotriazole (HBT), violuric acid (Vio), N-hydroxyacetanilide, N-hydroxy-N-phenylacetamide (NHA), methyl syringate, 10-phenothiazinepropionic acid, 2,2′-azinobis-(3-ethylbenzothiazoline)-6-sulfonic acid (ABTS), 2,2,6,6-tetramethyl-1-piperidinyloxy (TEMPO), 2-nitroso-1-naphthol-4-sulfonic acid (HNNS), Remazol Brilliant Blue, 3-hydroxyanthranilic acid and 2-pyridinecarboxylic acid.

11. The method of claim 1 wherein the keratin fibers to be treated are chosen from the group consisting of hair, wool, silk, furs and feathers.

12. The method of claim 1 wherein the substrates capable of the polymerization and the polyphenol oxidases are applied to the fibers simultaneously or, independently of one another, one after the other.

13. The method of claim 1 wherein the substrates capable of the polymerization and the polyphenol oxidase are applied to the keratin fibers to be treated in solution, in the form of a gel or in the form of an emulsion.

14. The method of claim 1 for improving the structure of hair and/or strengthening human hair.

15. The method of claim 1 for protecting keratin fibers against the harmful influence of light.

16. The method of claim 1 for improving the color fastness of colored keratin fibers.

17. A composition comprising
a) phenolic, enolic, arylaminic and/or enaminic substrates capable of the polymerization by means of polyphenol oxidases and
b) at least one polyphenol oxidase.

18. The composition of claim 17 further comprising a carrier.

19. The composition of claim 18 wherein the carrier is solid, liquid, gel-like or pasty.

20. The composition of claim 19 wherein the carrier is in the form of a solution, a gel or an emulsion.

21. The composition of claim 17 wherein the the polyphenol oxidase is present in an amount of from 0.1 to 50 U/ml, based on the 0.01 to 10% strength by weight substrate solution.

22. The composition of claim 17 wherein the substrates and the polyphenol oxidase are present in a total amount of from 0.01 to 10% by weight, based on the total composition, and the ratio of enzyme to substrate is preferably 1-10 U of polyphenol oxidase per 5-100 mg of substrate.

23. A composition for positively influencing tear strength, porosity, elasticity and volume of keratin fibers and/or their resistance to environmental influences and/or for positively influencing the color fastness and/or the resistance to washing of colored keratin fibers, comprising the composition of claim 17 in a solid, liquid, paste or gel carrier.

24. A kit comprising at least one substrate capable of polymerization by means of a polyphenol oxidase and at least one polyphenol oxidase in a composition as claimed in claim 17 spatially separate from one another.
